(19) United States
(12) Patent Application Publication
(10) Pub. No.: US 2019/0257652 A1
(43) Pub. Date: Aug. 22, 2019

(54) PHYSICAL QUANTITY DETECTION DEVICE, INCLINOMETER, INERTIAL MEASUREMENT UNIT, ELECTRONIC APPARATUS, VEHICLE, AND STRUCTURE MONITORING SYSTEM

(71) Applicant: Seiko Epson Corporation, Tokyo (JP)

(72) Inventor: Takahiro KAMETA, Okaya (JP)

(21) Appl. No.: 16/281,253

(22) Filed: Feb. 21, 2019

(30) Foreign Application Priority Data
Feb. 22, 2018 (JP) 2018-029434

(51) Int. Cl. G01C 19/56; G05D 1/08; G01C 9/06

(52) U.S. Cl. CPC G01C 19/56; G01C 9/06; G05D 1/0808

(57) ABSTRACT

A physical quantity detection device which made of a quartz crystal substrate having a plane including a Z′-axis and a Y′-axis, includes a base, a movable portion connected to the base, a physical quantity detection element connected to the base and the movable portion and detecting a physical quantity, and a supporter connected to the base and provided in a region opposite to the base side, and an outer edge of an inner side of a surface of a connection region to which the first portion along the Y′-axis and the second portion along an +X-direction of an X-axis includes a corner portion inclined with respect to the X-axis and 25°≤θ1≤35° is satisfied, where θ1 is an inclination angle of the corner portion with respect to the X-axis.

### BACKGROUND

### 1. Technical Field

The present invention relates to a physical quantity detection device, an inclinometer, an inertial measurement unit, an electronic apparatus, a vehicle, and a structure monitoring system.

### 2. Related Art

In the related art, a physical quantity detection device that uses a piezoelectric vibrator or the like as a physical quantity detection element and detects a physical quantity such as acceleration is known. Such a physical quantity detection device is configured to measure force applied to the physical quantity detection device from change in a resonance frequency of the physical quantity detection element caused by force acting in a detection axis direction.

As such a physical quantity detection device, for example, in JP-A-2014-85233, an acceleration sensor using a Z-cut (Z′-cut) quartz crystal substrate is described. The acceleration sensor includes a base, a movable portion connected to the base, a physical quantity detection element connected to the base and the movable portion, and a supporter connected to the base.

However, in recent years, further enhancement in sensitivity is demanded in such an acceleration sensor, and an acceleration sensor capable of realizing high sensitivity without lowering impact resistance which contrarily lowers sensitivity, that is, an acceleration sensor with high sensitivity while maintaining the impact resistance is demanded.

### SUMMARY

An advantage of some aspects of the invention is to solve at least a part of the problems described above, and the invention can be implemented as the following aspects or application examples.

### Application Example 1

A physical quantity detection device according to this application example includes a quartz crystal substrate having a plane including a Z′-axis and a Y′-axis, when an axis obtained by inclining a Z-axis by a rotation angle ϕ so that a +Z side rotates in a −Y-direction of a Y-axis is set as the Z′-axis and an axis obtained by inclining the Y-axis by the rotation angle ϕ so that a +Y side of the Y-axis rotates in a +Z-direction of the Z-axis is set as the Y′-axis, with an X-axis of an orthogonal coordinate system serving as the X-axis as an electric axis, the Y-axis as a mechanical axis, and the Z-axis as an optical axis of quartz crystal as a rotation axis, a base, a movable portion connected to the base, a physical quantity detection element connected to the base and the movable portion and detecting a physical quantity, and a supporter connected to the base, and in which an outer edge on an inner side of a surface of a connection region to which a first portion along the Y′-axis and a second portion along the +X-direction of the X-axis are connected includes a corner portion inclined with respect to the X-axis in a plan view and 25°≤θ1≤35° is satisfied, where θ1 is an inclination angle of the corner portion with respect to the X-axis.

In the physical quantity detection device according to this application example, the outer edge of a corner on an inner side of the surface of the connection region to which the first portion along the Y′-axis and the second portion along the +X-direction of the X-axis are connected is defined as a corner portion which is inclined so as to satisfy 25°≤θ1≤35°, as an inclination angle with respect to the X-axis.

At a corner portion on an inner side of a connection portion of the related art not inclined, during wet etching to form the physical quantity detection device, a residue (sometimes referred to as a “fin”) due to a crystalline plane with different rates of crystal growth due to anisotropy appears at the corner portion on an inner side of the connection portion to which the first portion along the Y′-axis and the second portion along the +X-direction of the X-axis are connected. When this residue appears, in a case where impact is applied to the physical quantity detection device, stress concentrates on the connection position (an end portion of the residue) between the residue and the first portion or the second portion, which may become a starting point of destruction such as folding of the first portion or the second portion.

In contrast, as in this application example, by making the corner on the inner side of the connection region to which the first portion along the Y′-axis and the second portion along the +X-direction of the X-axis are connected a corner portion inclined with respect to the X-axis so as to overlap the residue generated at the corner on the inner side of the connection portion, the crystalline plane having different etching rates disappears and thus, it is possible to prevent occurrence of the residue generated at the corner on the inner side of the connection portion. With this configuration, it is possible to obtain a physical quantity detection device with high sensitivity while maintaining the impact resistance.

### Application Example 2

In the physical quantity detection device according to the application example, it is preferable that the corner portion satisfies 300 μm≤t1≤500 μm and 100 μm≤L1≤500 μm, where t1 is a thickness of the corner portion and L1 is a length along the X-axis of the corner portion.

According to the physical quantity detection device according to this application example, it is possible to prevent occurrence of the residue generated at the inner corner portion of the connection portion by setting a relationship between t1 which is the thickness of the corner portion and L1 which is the length along the X-axis of the corner portion so as to satisfy the range described above.

### Application Example 3

In the physical quantity detection device according to the application example, it is preferable that an outer edge on an inner side of a surface of a connection region to which a third portion along the Y′-axis and a fourth portion along the −X-direction of the X-axis are connected includes a second corner portion inclined with respect to the X-axis in a plan view and 25°≤θ2≤35° is satisfied, where θ2 is an inclination angle of the corner portion with respect to the X-axis.

According to the physical quantity detection device according to this application example, by making the outer edge on the inner side of the connection region, to which the third portion along the Y′-axis and the fourth portion along the −X-direction of the X-axis are connected a second corner portion inclined with respect to the X-axis so as to overlap the residue generated at the inner corner portion of the connection portion, the crystalline plane having different etching rates disappears and thus, it is possible to prevent occurrence of the residue generated at the corner portion on the inner side of the surface of the connection region. With this configuration, it is possible to obtain a physical quantity detection device with high sensitivity while maintaining the impact resistance.

### Application Example 4

In the physical quantity detection device according to the application example, it is preferable that the second corner portion satisfies 300 μm≤t2≤500 μm and 100 μm≤L2≤500 μm, where t2 is a thickness of the second corner portion and L2 is a length along the X-axis of the second corner portion.

According to the physical quantity detection device according to this application example, it is possible to prevent occurrence of the residue generated at the corner portion on the inner side the connection portion by setting a relationship between t2 which is the thickness of the second corner portion and L2 which is the length along the X-axis of the second corner portion so as to satisfy the range described above.

### Application Example 5

In the physical quantity detection device according to the application example, it is preferable that the physical quantity detection element includes a first base, a second base, and a vibrating portion which is disposed between the first base and the second base and is connected to the first base and the second base in a plan view.

According to the physical quantity detection device according to this application example, it is possible to detect the physical quantity with high accuracy, by using such a physical quantity detection element.

### Application Example 6

In the physical quantity detection device according to the application example, it is preferable that the vibrating portion is configured by a plurality of vibrating arms arranged side by side with a gap therebetween in a plan view.

According to the physical quantity detection device according to this application example, it is possible to detect the physical quantity with high accuracy by including the vibrating portion configured by a plurality of vibrating arms arranged side by side with a gap therebetween.

### Application Example 7

In the physical quantity detection device according to the application example, it is preferable that the physical quantity is acceleration.

According to the physical quantity detection device according to this application example, it is possible to obtain a physical quantity detection device capable of detecting acceleration with high sensitive while maintaining impact resistance.

### Application Example 8

An inclinometer according to this application example includes the physical quantity detection device according to the application example 1 and a circuit that calculates an inclination based on an output signal from the physical quantity detection device.

According to the inclinometer according to this application example, since the inclination is calculated based on the output signal from the physical quantity detection device which is detected with high sensitivity while maintaining the impact resistance, it is possible to calculate the inclination with improved reliability.

### Application Example 9

An inertial measurement unit according to this application example includes the physical quantity detection device according to the application example 7, an angular velocity detection device, and a circuit for calculating an attitude based on an output signal from the physical quantity detection device and an output signal from the angular velocity detection device.

According to the inertial measurement unit according to this application example, since the attitude is calculated by the circuit based on acceleration measured with high sensitivity and the angular velocity measured from the angular velocity detection device while maintaining impact resistance, it is possible to obtain an inertial measurement unit capable of outputting highly reliable physical quantity data (acceleration data and angular velocity data).

### Application Example 10

An electronic apparatus unit according to this application example includes the physical quantity detection device according to the application example 1 and a controller that performs control based on an output signal from the physical quantity detection device.

According to the electronic apparatus unit according to this application example, since the physical quantity detection device described above is mounted, it is possible to achieve the effect of the physical quantity sensor described above and to obtain an electronic apparatus with high reliability.

### Application Example 11

A vehicle according to this application example includes the physical quantity detection device according to the application example 1 and an attitude controller that controls an attitude based on a detection signal output from the physical quantity detection device.

According to the vehicle unit according to this application example, since the physical quantity detection device as described above is mounted, it is possible to achieve the effect of the physical quantity sensor described above and to obtain a vehicle with high reliability.

### Application Example 12

A structure monitoring system according to this application example includes the physical quantity detection device according to the application example 1 attached to a structure, a receiver that receives a detection signal of the physical quantity detection device, and a calculator that calculates an inclination angle of the structure based on the output signal output from the receiver.

According to the structure monitoring system according to this application example, since the inclination angle of the structure is calculated from the detection result of the physical quantity detection device detected with high sensitivity while maintaining impact resistance, it is possible to achieve the effect of the physical quantity sensor described above and to obtain a structure monitoring system with high reliability.

### BRIEF DESCRIPTION OF THE DRAWINGS

The invention will be described with reference to the accompanying drawings, wherein like numbers reference like elements.

FIG. 1 is a perspective view schematically illustrating a physical quantity detection device according to a first embodiment.

FIG. 2 is a perspective view schematically illustrating the physical quantity detection device according to the first embodiment.

FIG. 3 is a plan view schematically illustrating the physical quantity detection device according to the first embodiment.

FIG. 4 is an enlarged plan view illustrating a connection portion (corner) of the physical quantity detection device.

FIG. 5 is an enlarged plan view illustrating a residue occurring in a connection portion (corner) of the related art.

FIG. 6 is a graph illustrating correlation between a length (L) of the corner portion and shear strength (g).

FIG. 7 is a cross-sectional view taken along line VII-VII of FIG. 3 schematically illustrating a bonding state of the physical quantity detection element.

FIG. 8A is a cross-sectional view illustrating an operation state of the physical quantity detection device.

FIG. 8B is a cross-sectional view illustrating another operation state of the physical quantity detection device.

FIG. 9 is a perspective view schematically illustrating a physical quantity detection device according to a second embodiment.

FIG. 10 is a plan view schematically illustrating the physical quantity detection device according to the second embodiment.

FIG. 11 is an enlarged plan view illustrating the connection portion (corner) of the physical quantity detection device.

FIG. 12 is a perspective view schematically illustrating a physical quantity detection device according to a third embodiment.

FIG. 13 is a plan view schematically illustrating the physical quantity detection device according to the third embodiment.

FIG. 14 is a perspective view schematically illustrating a physical quantity detection device according to a fourth embodiment.

FIG. 15 is a plan view schematically illustrating the physical quantity detection device according to the fourth embodiment.

FIG. 16 is an enlarged plan view illustrating a connection portion (corner) of the physical quantity detection device.

FIG. 17 is a cross-sectional view schematically illustrating a physical quantity detector.

FIG. 18 is a functional block diagram illustrating a schematic configuration of an inclinometer.

FIG. 19 is an exploded perspective view illustrating a schematic configuration of an inertial measurement unit.

FIG. 20 is a perspective view illustrating a disposition example of inertial sensor elements of the inertial measurement unit.

FIG. 21 is a perspective view schematically illustrating a configuration of a mobile personal computer which is an example of an electronic apparatus.

FIG. 22 is a perspective view schematically illustrating a configuration of a smartphone (mobile phone) which is an example of the electronic apparatus.

FIG. 23 is a perspective view illustrating a configuration of a digital still camera which is an example of the electronic apparatus.

FIG. 24 is a perspective view illustrating a configuration of an automobile which is an example of a vehicle.

FIG. 25 is a function block diagram illustrating an outline of a structure monitoring system.

### DESCRIPTION OF EXEMPLARY EMBODIMENTS

Hereinafter, embodiments of the invention will be described with reference to the drawings. In each of the drawings illustrated below, in order to make each constituent elements large enough to be recognized on the drawing, the dimension and ratio of each component may be described as being different from the actual component as appropriate.

### Physical Quantity Detection Device

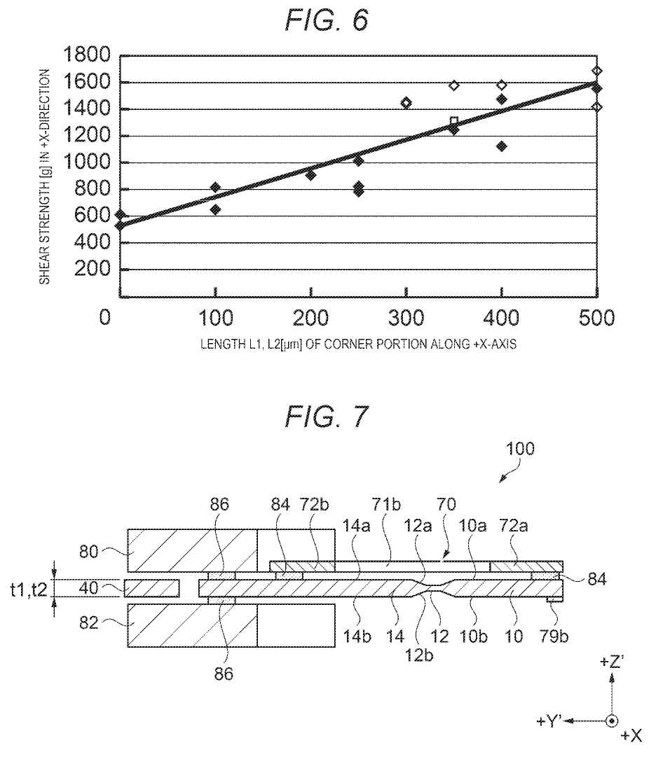

In each drawing (excluding FIG. 6) referred to in description of the physical quantity detection device according to a first to third embodiments below, the X-axis, Y′-axis, and Z′-axis are illustrated as three axes orthogonal to each other. Description will be made on an example in which, for the respective axes in the drawing, when an axis obtained by inclining the Z-axis by a rotation angle ϕ so that the +Z side rotates in the −Y-direction of the Y-axis is defined as the Z′-axis and an axis obtained by inclining the Y-axis by the rotation angle ϕ so that the +Y side of the Y-axis rotates in the +Z-direction of the Z-axis is defined as the Y′-axis with an X-axis of an orthogonal coordinate system including the X-axis as an electric axis, the Y-axis as a mechanical axis, and the Z-axis as an optical axis of quartz crystal, which is a piezoelectric material used as a base material of a physical quantity detection device, as a rotation axis, a so-called quartz crystal Z plate (Z′ plate) which is cut along a plane defined by the X-axis and the Y′-axis, processed into a flat plate shape and has a predetermined thickness t in the Z′-axis direction orthogonal to the plane is used as a base material. The Z′-axis is an axis along the direction in which gravity acts in a physical quantity detection device 100.

In view of the frequency-temperature characteristic, from the viewpoint that the quartz crystal Z plate (Z′ plate) used as the base material reduces change in the resonance frequency due to temperature change, it is preferable that the rotation angle ϕ is in a range of −5 degrees or more and 15 degrees or less (−5°≤ϕ≤15°).

### First Embodiment

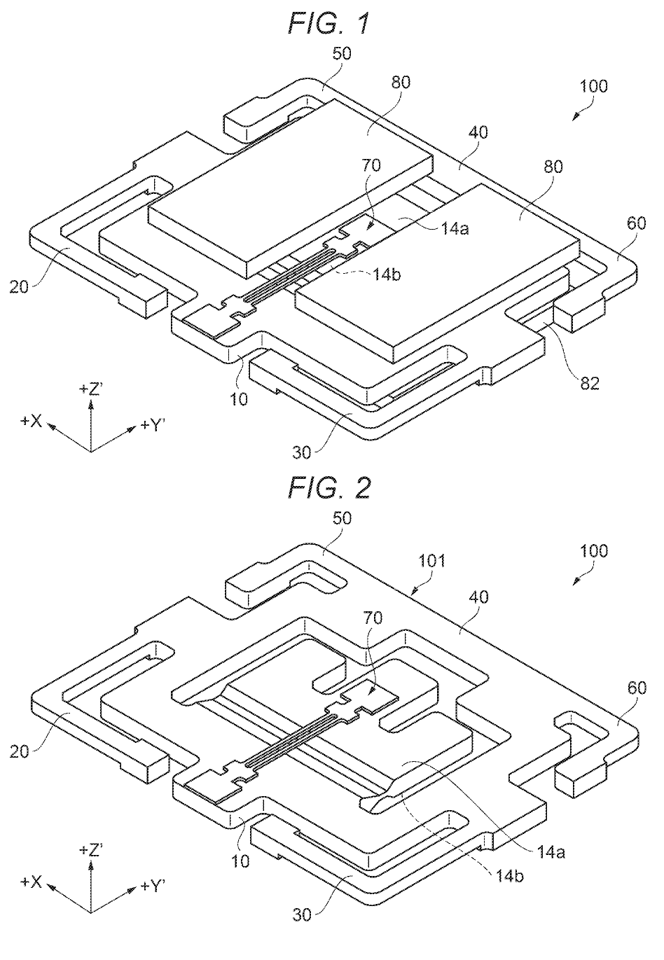

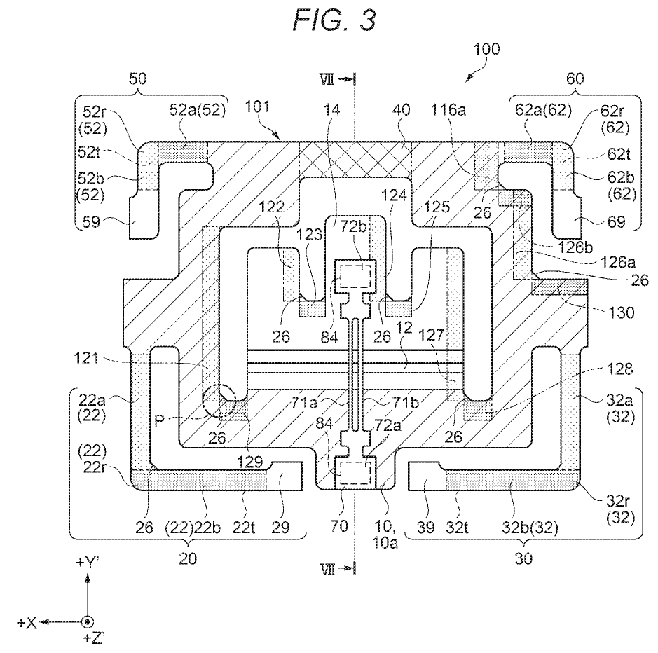

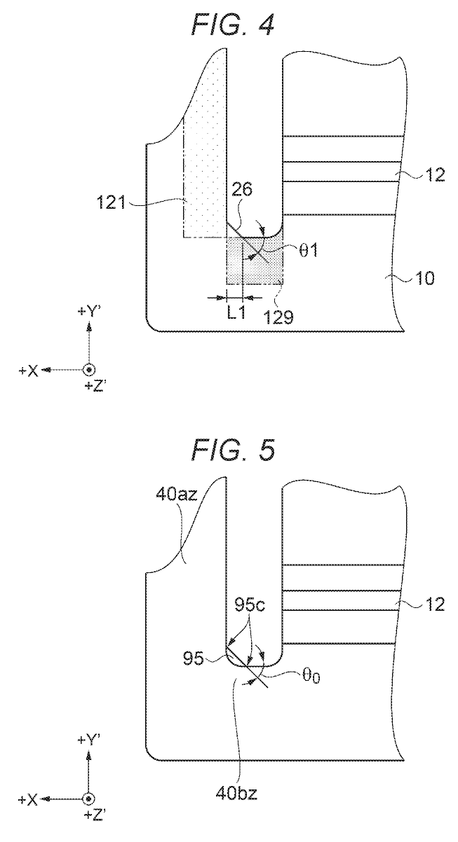

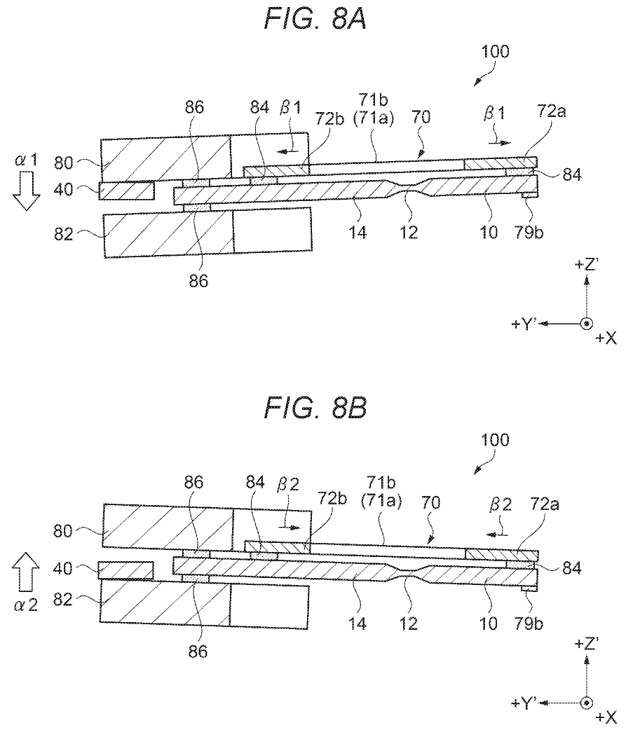

A physical quantity detection device according to a first embodiment will be described with reference to FIGS. 1 to 7, and FIGS. 8A and 8B. FIG. 1 is a perspective view schematically illustrating a physical quantity detection device according to a first embodiment. FIG. 2 is a perspective view schematically illustrating the physical quantity detection device according to the first embodiment. FIG. 3 is a plan view schematically illustrating the physical quantity detection device according to the first embodiment. FIG. 4 is an enlarged plan view illustrating a connection portion (corner portion) of the physical quantity detection device. FIG. 5 is an enlarged plan view illustrating a residue occurring in a connection portion (corner portion) of the related art. FIG. 6 is a graph illustrating correlation between a length (L) of the corner portion and shear strength (g). FIG. 7 is a cross-sectional view taken along line VII-VII of FIG. 3 schematically illustrating a bonding state of the physical quantity detection element. FIGS. 8A and 8B are cross-sectional views illustrating an operation state of the physical quantity detection device. For convenience of explanation, illustration of mass portions 80 and 82 and a mass bonding material 86 is omitted in FIG. 2, and illustration of the mass portions 80 and 82 is omitted in FIG. 3.

### Structure of Physical Quantity Detecting Device

First, a configuration of the physical quantity detection device 100 according to the first embodiment will be described with reference to FIGS. 1 to 3. The physical quantity detection device 100 according to the first embodiment includes a substrate structure 101 including a base 10 and the like, a physical quantity detection element 70 connected to the substrate structure 101 to detect a physical quantity, and mass portions 80 and 82.

The substrate structure 101 of the physical quantity detection device 100 according to this embodiment includes the base 10 (a region indicated by a hatching that rises to the right in a plan view) which is identified by oblique lines, a joint portion 12, a movable portion 14 connected to the base 10, a connection portion 40, a first supporter 20, a second supporter 30, a third supporter 50, and a fourth supporter 60 which are provided so as to be connected to base 10 in FIG. 3. Here, the third supporter 50 and the fourth supporter 60 are connected through the connection portion 40.

Specifically, the first supporter 20 is disposed on the plus side of the X-axis of the base 10 in a plan view. The second supporter 30 is disposed on the negative side of the X-axis of the base 10 in a plan view. The third supporter 50 is disposed on the plus side of the Y-axis with respect to the first supporter 20 in a plan view and is disposed on the plus side of the X-axis of the base 10. The fourth supporter 60 is disposed on the plus side of the Y-axis with respect to the second supporter 30 in a plan view and is disposed on the negative side of the X-axis of the base 10.

The physical quantity detection device 100 of this embodiment exemplifies a form including four supporters (first supporter 20, second supporter 30, third supporter 50, and fourth supporter 60) as an example. However, the number of the supporters to be provided is not limited to the first to fourth portions described above, and may be appropriately changed according to the condition of the physical quantity to be detected and the like. For example, a configuration in which there is no connection portion 40 which is disposed between the third supporter 50 and the fourth supporter 60 and connects the third supporter 50 and the fourth supporter 60, and the third supporter 50 and the fourth supporter 60 are not connected may be available.

The substrate structure 101 uses a quartz crystal substrate of a quartz crystal Z-plate (Z′ plate) cut out from a quartz crystal rough stone or the like which is a piezoelectric material at a predetermined angle as described above. By patterning the quartz crystal substrate, the elements are integrally formed as a substrate structure 101. The patterning can be performed by using, for example, a photolithography technique and a wet etching technique.

The base 10 is connected to the movable portion 14 through the joint portion 12 and supports the movable portion 14. The base 10 is connected to the movable portion 14 through the joint portion 12, the connection portion 40 positioned on a side opposite to a side where the joint portion 12 of the movable portion is positioned, the first supporter 20 and the second supporter 30, and the third supporter 50 and the fourth supporter 60 that are connected to each other through the connection portion 40. The base 10 of this embodiment is configured by a region up to the connection portions with respective connected portions (joint portion 12, connection portion 40, first supporter 20, and second supporter 30) and means a region indicated by hatching that rises to the right in a plan view in FIG. 3. However, the region constituting the base 10 is not strictly defined, and the position of the boundary line thereof can be appropriately determined.

The joint portion 12 is provided between the base 10 and the movable portion 14, and is connected to the base 10 and the movable portion 14. A thickness (length in the Z′-axis direction) of the joint portion 12 is thin (short) as compared with a thickness of the base 10 and a thickness of the movable portion 14, and is formed in a constricted shape in a cross-sectional view from the X-axis direction. The joint portion 12 can be provided by forming thin thickness portions 12a and 12b (see FIG. 7), for example, by performing so-called half etching of the substrate structure 101 including the joint portion 12. In this embodiment, the thin thickness portions 12a and 12b are provided along the X-axis direction. The joint portion 12 functions as a rotation axis along the X-axis direction as a fulcrum (intermediate hinge) when the movable portion 14 is displaced (rotated) with respect to the base 10. The first supporter 20, the second supporter 30, the third supporter 50, and the fourth supporter 60, which will be described later, are connected to the base 10.

As long as a portion of the substrate structure 101 is made thin so that the movable portion 14 has flexibility, the joint portion 12 having the constricted shape may also be configured to have a recessed groove formed on one of the two main surfaces of the substrate structure 101, in addition to the shapes formed on both main surfaces of the substrate structure 101 as illustrated in the drawing. The constricted joint portion 12 having the constricted shape may be configured to have a shape obtained by cutting at least one of the two principal surfaces of the substrate structure 101 into a semicircular shape, for example, in a cross-sectional view from the X-axis direction.

The movable portion 14 is connected to the base 10 through the joint portion 12. In this embodiment, the movable portion 14 is provided on the side opposite to the base 10 in the +Y′-axis direction, along the Y′-axis direction, with respect to the joint portion 12. The movable portion 14 has a plate-like shape, and has main surfaces 14a and 14b which are facing each other along the Z′-axis direction and are in a front and back relationship. The movable portion 14 can be displaced in a direction (Z′-axis direction) intersecting with the main surfaces 14a and 14b with the joint portion 12 as a fulcrum (rotation axis) in accordance with the accelerations α1 and α2 (see FIGS. 8A and 8B) which is a physical quantity applied in the direction (Z′-axis direction) intersecting with the main surfaces 14a and 14b.

The connection portion 40 extends from the base 10 on the +X-direction side on which the third supporter 50 which will be described later is provided so as to surround the movable portion 14 along the X-axis direction and is provided so as to be connected to the base 10 on the −X-direction side where the fourth supporter 60 which will be described later is provided. The connection portion 40 is a region indicated by cross hatching in FIG. 3 as an example. However, the connection portion 40 may be configured to be included in the base 10. In this case, a region obtained by combining the region of the base 10 and the region of the connection portion 40 illustrated in FIG. 3 may be used as the base 10.

### Structures of First Supporter and Second Supporter

The first supporter 20 and the second supporter 30 illustrated in FIG. 3 are provided symmetrically in the same configuration with respect to the physical quantity detection element 70 in the same figure. In other words, the first supporter 20 and the second supporter 30 are provided linearly-symmetrically with the line segment VII-VII which is set in the Y′-axis direction in which the physical quantity detection element 70 extends as a center line.

The first supporter 20 includes an arm portion 22 and a first fixed portion 29. The arm portion 22 includes a first arm portion 22a and a second arm portion 22b through a first curved portion 22r. The first supporter 20 extends from the base 10 on the +X-axis direction side and is provided with the first fixed portion 29 on an end portion opposite to the base 10, that is, on a tip end side of the first supporter 20. In the first supporter 20, the first fixed portion 29 provided on the tip side of the first supporter 20 is fixed to a package (not illustrated) as an object to be fixed, and supports the base 10. Here, the first arm portion 22a is a portion extending along the Y-axis direction and the second arm portion 22b is a portion extending along the X-axis direction. As an example of the division of the first arm portion 22a and the second arm portion 22b, in FIG. 3, the first arm portion 22a is illustrated with light hatching and the second arm portion 22b is illustrated with dark hatching to indicate respective regions of the first and second arm portions.

In a case where the first supporter 20 (physical quantity detection device 100) is viewed from above in the direction in which the movable portion 14 displaces (Z′-axis direction), the first supporter 20 is provided such that the first arm portion 22a extends from the base 10 along the Y′-axis, in the −Y′-axis direction. The first supporter 20 includes a first curved portion 22r on the side opposite to the base 10 of the first arm portion 22a, and is provided with the second arm portion 22b through the first curved portion 22r. The second arm portion 22b is provided along the X-axis from the first curved portion 22r, in the −X-axis direction. Further, the second arm portion 22b is connected to the first fixed portion 29 on the side opposite to the first curved portion 22r.

The arm portion 22 is positioned between the base 10 and the first fixed portion 29, and is provided with a recessed portion 22t which is recessed from the second surface 10b side which is the surface on the back side of the first surface 10a where the physical quantity detection element 70 is provided. In other words, due to the recessed portion 22t, the first fixed portion 29 has a convex shape protruding in the −Z′-axis direction. It is preferable that the thickness of the recessed portion 22t is in the range of 40% to 60% of the thickness of the base 10. As such, the first fixed portion 29 is provided such that the second surface 10b side to be joined to the object to be fixed protrudes from the recessed portion 22t. Accordingly, when connecting to the object to be fixed, the first fixed portion 29 can selectively make contact (connect) the second surface 10b side and the object to be fixed. In other words, it is possible to prevent the arm portion 22 from coming into contact with the object to be fixed.

The second supporter 30 includes an arm portion 32 and a second fixed portion 39. The arm portion 32 includes a third arm portion 32a and a fourth arm portion 32b through a second curved portion 32r. The second supporter 30 extends from the base 10 on the −X-axis direction side and is provided with the second fixed portion 39 on an end portion opposite to the base 10, that is, on a tip end side of the second supporter 30. Similar to the first supporter 20, in the second supporter 30, the second fixed portion 39 provided on the tip side of the second supporter 30 is fixed to a package (not illustrated) as an object to be fixed, and supports the base 10. Here, the third arm portion 32a is a portion extending along the Y-axis direction, and the fourth arm portion 32b is a portion extending along the X-axis direction. As an example of the division of the third arm portion 32a and the fourth arm portion 32b, in FIG. 3, the third arm portion 32a is illustrated with light hatching and the fourth arm portion 32b is illustrated with dark hatching to indicate respective regions of the third and fourth arm portions.

In a case where the second supporter 30 (physical quantity detection device 100) is viewed from above in the direction in which the movable portion 14 displaces (Z′-axis direction), the second supporter 30 is provided such that the third arm portion 32a extends from the base 10 along the Y′-axis, in the −Y′-axis direction. The second supporter 30 includes the second curved portion 32r on the side opposite to the base 10 of the third arm portion 32a, and is provided with the fourth arm portion 32b through the second curved portion 32r. The fourth arm portion 32b is provided along the X-axis from the second curved portion 32r, in the +X-axis direction. The fourth arm portion 32b is connected to the second fixed portion 39 on the side opposite to the second curved portion 32r.

Since the arm portion 32, the recessed portion 32t, and the second fixed portion 39 in the second supporter 30 have the same structure as the arm portion 22, the recessed portion 22t, and the first fixed portion 29 of the first supporter 20, description thereof is omitted.

### Structures of Third Supporter and Fourth Supporter

The third supporter 50 and the fourth supporter 60 illustrated in FIG. 3 are provided symmetrically in the same configuration with respect to the physical quantity detection element 70 in the same figure. In other words, the third supporter 50 and the fourth supporter 60 are provided symmetrically with the line segment VII-VII which is set in the Y′-axis direction in which the physical quantity detection element 70 extends as a center line.

The third supporter 50 includes an arm portion 52 and a third fixed portion 59. The arm portion 52 includes a fifth arm portion 52a, a sixth arm portion 52b, and a third curved portion 52r. The third supporter 50 extends from the base 10 through the connection portion 40, and a third fixed portion 59 is provided on the side opposite to the connection portion 40, that is, on the tip end side of the third supporter 50. The third fixed portion 59 is fixed to a package (not illustrated) as an object to be fixed, which will be described later, and is provided to support the base 10.

The third supporter 50 is provided extending from the base 10 through the connection portion 40 to the third fixed portion 59. In a case where the third supporter 50 (physical quantity detection device 100) is viewed from above in the direction in which the movable portion 14 is displaced (Z′-axis direction), the third supporter 50 is provided such that the fifth arm portion 52a extends from the base 10 through the connection portion 40 along the X-axis, in the +X-axis direction. The third supporter 50 includes a third curved portion 52r on the side opposite to the connection portion 40 of the fifth arm portion 52a, and is provided with the sixth arm portion 52b through the third curved portion 52r. The sixth arm portion 52b is provided along the Y′-axis from the third curved portion 52r, in the −Y′-axis direction. The sixth arm portion 52b is connected to the third fixed portion 59 on the side opposite to the third curved portion 52r. Here, as an example of the division of the fifth arm portion 52a and the sixth arm portion 52b, in FIG. 3, the fifth arm portion 52a is subjected to dark hatching and the sixth arm portion 52b is subjected to different hatching Area.

The arm portion 52 is positioned between the base 10 and the third fixed portion 59 through the connection portion 40 and is provided with a recessed portion 52t which is recessed from the second surface 10b side which is the surface on the back side of the first surface 10a where the physical quantity detection element 70 is provided. In other words, due to the recessed portion 52t, the third fixed portion 59 has a convex shape protruding in the −Z′-axis direction. It is preferable that the thickness of the recessed portion 52t is in the range of 40% to 60% of the thickness of the base 10. As such, the third fixed portion 59 is provided such that the second surface 10b side to be joined to the object to be fixed protrudes from the recessed portion 52t. Accordingly, when connecting to the object to be fixed, the third fixed portion 59 can selectively make contact (connect) the second surface 10b side and the object to be fixed. In other words, it is possible to prevent the arm portion 52 from coming into contact with the object to be fixed.

The fourth supporter 60 includes an arm portion 62 and a fourth fixed portion 69. The arm portion 62 includes a seventh arm portion 62a and an eighth arm portion 62b through a fourth curved portion 62r. The fourth supporter 60 extends from the base 10 through the connection portion 40 and is provided with the fourth fixed portion 69 on an end portion on a side opposite to the connection portion 40, that is, on a tip end side of the fourth supporter 60. Similar to the third supporter 50, in the fourth supporter 60, the fourth fixed portion 69 provided on the tip side of the third supporter 50 is fixed to a package (not illustrated) as an object to be fixed, and supports the base 10 through the connection portion 40.

In a case where the fourth supporter 60 is viewed from above in the direction in which the movable portion 14 displaces (Z′-axis direction), the fourth supporter 60 is provided such that the seventh arm portion 62a extends from the base 10 through the connection portion 40 along the X-axis, in the −X-axis direction. Further, the fourth supporter 60 includes a fourth curved portion 62r on the side opposite to the connection portion 40 of the seventh arm portion 62a, and is provided with an eighth arm portion 62b through the fourth curved portion 62r. The eighth arm portion 62b is provided extending from the fourth curved portion 62r along the Y′-axis, in the −Y′-axis direction. The eighth arm portion 62b is connected to the fourth fixed portion 69 on the side opposite to the fourth curved portion 62r. Here, as an example of the division of the seventh arm portion 62a and the eighth arm portion 62b, in FIG. 3, the seventh arm portion 62a is illustrated with dark hatching and the eighth arm portion 62b is illustrated with light hatching to indicate respective regions of the seventh and eight arm portions.

Since the arm portion 62, the recessed portion 62t, and the fourth fixed portion 69 in the fourth supporter 60 have the same structure as the arm portion 52, the recessed portion 52t, and the third fixed portion 59 of the third supporter 50, description thereof is omitted.

In the physical quantity detection device 100 of this embodiment, the respective recessed portions 22t, 32t, 52t, and 62t provided in the respective supporters (first supporter 20, second supporter 30, third supporter 50, and fourth supporter 60) are provided so as to surround the movable portion 14.

When a substrate structure of the related art is formed by wet etching from a quartz crystal substrate using a quartz crystal substrate of a quartz crystal Z plate (Z′ plate) as described above, as illustrated in FIG. 5, at the inner side of the connection portion to which a first portion (In this embodiment, for example, the first portion corresponds to the first portion 121. Hereinafter, it will be described as the “first portion 40az”) along the Y′-axis and a second portion (In this embodiment, for example, the second portion corresponds to the second portion 129. Hereinafter, it will be described as the “second portion 40bz”) along the +X-direction of the X-axis are connected, a residue 95 (sometimes referred to as a “fin”) due to a crystalline plane with different rates of crystal growth due to anisotropy of etching appears. The residue 95 has a substantially triangular shape with an inclination angle θ₀ with respect to the inner wall surface of the second portion 40bz and extends over the inner wall surface of the first portion 40az and the inner wall surface of the second portion 40bz. When such a residue 95 appears, in a case where excessive impact is applied to the physical quantity detection device 100, for example, stress concentrates on a connection position 95c (end portion of the residue) between the residue 95 and the first portion 40az or the second portion 40bz, which may become a starting point at which cracks are generated in the connection region between the first portion 40az and the second portion 40bz, or a starting point of destruction such as folding of the first portion 40az or the second portion 40bz, which is one of the causes of lowering the impact resistance.

In view of such a phenomenon, in the substrate structure 101 of this embodiment, as a representative example, as illustrated in FIG. 4, at the corner on the inner side of the surface of the connection region to which the first portion 121 provided along the Y′-axis and the second portion 129 provided along the +X-direction of the X-axis are connected, a configuration in which an inclined portion 26 as a corner portion in which the inclination angle θ1 of the outer edge thereof with respect to the X-axis is inclined so as to satisfy 25°≤θ1≤35° is provided is adopted. The inclined portion 26 is provided to be inclined with respect to the X-axis so as to overlap the residue 95 (see FIG. 5) appearing in a case where the inclined portion 26 is not provided in a plan view in the Z′-axis direction. In the substrate structure 101 of this embodiment, the inclined portions 26 as the corner portions are disposed at seven places.

When the thickness of the inclined portion 26 is t1 (in other words, it can be regarded as the thickness of the base 10 (see FIG. 7)) and the length of the inclined portion 26 along the X-axis is L1, as illustrated in FIG. 4, the inclined portion 26 is preferably provided to satisfy 300 μm≤t1≤500 μm and 100 μm≤L1≤500 μm. As can be seen from the graph of FIG. 6, when the length L1 of the inclined portion 26 along the X-axis is 100 μm≤L1≤500 μm, the shear strength in the X-direction clearly increases. In the evaluation result illustrated in FIG. 6, when the length L1 along the X-axis of the inclined portion 26 is set to 100 μm as compared with the configuration without the inclined portion 26 (L1=0: zero), a shear strength of approximately 1.2 times can be obtained, and when the length L1 is set to 500 μm, a shear strength of approximately 2.5 times can be obtained.

As such, since the crystalline plane having different etching rates disappears (the crystalline plane is difficult to occur) by providing the inclined portion 26 as the corner portion having the configuration described above at the inner side of the connection portion to which the first portion 121 provided along the Y′-axis and the second portion 129 provided along the +X-axis direction of the X-axis are connected, it is possible to prevent occurrence of the residue 95 generated at the inner side of the connection portion of the related art in which the inclined portion 26 is not provided. With this configuration, in a case where an impact is applied to the physical quantity detection device 100, a stress concentrated portion that can become a starting point of destruction such as folding can be eliminated and impact resistance of the physical quantity detection device 100 can be improved.

In addition to the inner side of the connection portion to which the first portion 121 and the second portion 129 are connected as described above as the representative example, the inclined portion 26 can also be disposed at the connection portion to which the first portion 121 provided along the Y′-axis and the second portion 129 provided along the +X-direction of the X-axis are connected, and the same effect can be achieved. Specifically, the inclined portion 26 in this embodiment is provided at a connection portion between the first portion 122 and the second portion 123, a connection portion between the first portion 124 and the second portion 125, a connection portion between the first portion 116a and the second portion 126b, a connection portion between the first portion 126a and the second portion 130, a connection portion between the first portion 127 and the second portion 128, the first arm portion 22a as a first portion and the second arm portion 22b as a second portion, as other disposition places. In FIG. 3, approximate regions in each of the first portion 121 and the second portion 129 are indicated by hatching.

### Physical Quantity Detection Element

As illustrated in FIGS. 3 and 7, the physical quantity detection element 70 is provided so as to be connected to the base 10 and the movable portion 14 of the substrate structure 101. In other words, the physical quantity detection element 70 is provided so as to straddle the base 10 and the movable portion 14 of the substrate structure 101. The physical quantity detection element 70 includes vibrating beam portions 71a and 71b as vibrating portions, a base 72a as a first base, and abase 72b as a second base. In the physical quantity detection element 70 of this embodiment, for example, as the movable portion 14 is displaced according to the physical quantity, stress is generated in the vibrating beam portions 71a and 71b, and physical quantity detection information generated in the vibrating beam portions 71a and 71b changes. In other words, a vibration frequency (resonance frequency) of the vibrating beam portions 71a and 71b changes. In this embodiment, the physical quantity detection element 70 is a double-tuning fork element (double-tuning fork type vibration element) including two vibrating beam portions 71a and 71b and a pair of bases 72a and 72b. Each of vibrating beam portions 71a and 71b as the vibrating portion may be referred to as a vibrating arm, a vibrating beam, or a columnar beam.

The vibrating beam portions 71a and 71b are provided so as to extend between the base 72a and the base 72b along the Y′-axis direction in which the movable portion 14 extends. The vibrating beam portions 71a and 71b are arranged side by side with a gap therebetween. The shape of the vibrating beam portions 71a and 71b is, for example, a prismatic shape. When a driving signal is applied to excitation electrodes (not illustrated) provided in the vibrating beam portions 71a and 71b, the vibrating beam portions 71a and 71b can bend and vibrate so that the vibrating beam portions 71a and 71b are separated from or approach each other along the X-axis direction. In the case where the number of vibrating beam portions 71a and 71b are two as in this embodiment, the vibrating beam portions 71a and 71b vibrates so that the centers thereof in the longitudinal direction are separated from each other and approach each other, that is, in a so-called reverse phase mode, and accordingly, the pair of vibrating beam portions 71a and 71b vibrate with symmetry and thus, vibration leakage to the outside can be reduced.

The bases 72a and 72b are connected to both ends of the vibrating beam portions 71a and 71b. In the form illustrated in FIG. 3, the base 72a is fixed to a first surface 10a (surface on which the physical quantity detection element 70 is provided) of the base 10 through a detection element bonding material 84. The base 72b is connected to a main surface 14a (main surface on the same side as the first surface 10a of the base 10) of the movable portion 14 through the detection element bonding material 84. As the detection element bonding material 84, for example, low melting point glass or an alloy coating film of gold (Au) and tin (Sn) capable of being subjected to eutectic bonding is used.

For the physical quantity detection element 70 in this embodiment, a quartz crystal substrate of a quartz crystal Z plate (Z′ plate) which is cut at a predetermined angle from a quartz crystal rough stone or the like which is a piezoelectric material, similarly to the substrate structure 101 described above, is used. The physical quantity detection element 70 is formed by patterning the quartz crystal substrate by a photolithography technique and an etching technique. With this configuration, the vibrating beam portions 71a and 71b and the bases 72a and 72b can be integrally formed.

The material of the physical quantity detection element 70 is not limited to the quartz crystal substrate described above. For example, piezoelectric materials such as lithium tantalate (LiTaO₃), lithium tetraborate (Li₂B₄O₇), lithium niobate (LiNbO₃), lead zirconate titanate (PZT), zinc oxide (ZnO), and aluminum nitride (AlN) can be used. Further, a semiconductor material such as silicon having a piezoelectric material (piezoelectric material) film such as zinc oxide (ZnO) or aluminum nitride (AlN) can be used. However, it is preferable to use the same material as the substrate structure 101.

A lead-out electrode (not illustrated) is provided, for example, on the base 72a of the physical quantity detection element 70. The lead-out electrode is electrically connected to an excitation electrode (not illustrated) provided in the vibrating beam portions 71a and 71b.

The lead-out electrode is electrically connected to a connection terminal (not illustrated) provided on the first surface 10a of the base 10 by a metal wire (not illustrated) such as gold (Au), aluminum (Al) or the like. The connection terminal is electrically connected to a fixed portion connection terminal 79b (not illustrated in FIG. 3) by a wiring (not illustrated).

For the excitation electrode, the lead-out electrode, the connection terminal, and the fixed portion connection terminal 79b for example, a laminate on which a chromium (Cr) layer as a base and a gold (Au) layer are laminated is used. The excitation electrode, the lead-out electrode, the connection terminal, and the external connection terminal are provided by, for example, forming a conductive layer by a sputtering method or the like and patterning the conductive layer.

As illustrated in FIGS. 1 and 7, the mass portions 80 and 82 are provided on the main surface 14a of the movable portion 14 and the main surface 14b serving as the back surface in a front and back relationship between the main surface 14a and the main surface 14b. More specifically, the mass portion 80 is provided on the main surface 14a through the mass bonding material 86, and the mass portion 82 is provided on the main surface 14b through the mass bonding material 86. As the material of the mass portions 80 and 82, for example, metals such as copper (Cu) and gold (Au) may be included. As the mass bonding material 86, for example, a thermosetting adhesive containing silicone resin can be used.

In this embodiment, two mass portions 80 and 82 are provided on each of the main surfaces 14a and 14b of the movable portion 14. However, the invention is not limited to this, and one or a plurality of mass portions 80 and 82 may be provided on either one of the main surfaces 14a and 14b.

In this embodiment, the physical quantity detection element 70 is configured by the double-tuning fork vibrator in which the vibrating portion is configured by two columnar beams of the vibrating beam portions 71a and 71b, but the double-tuning fork vibrator may be configured by one columnar beam (single beam). With this configuration, since the force applied from the first base (base) 72a and the second base (base) 72b increases with respect to the columnar beam, the amount of change in the resonance frequency increases, and accordingly, sensitivity of the physical quantity detection element 70 can be improved.

Further, it is possible to configure the vibrating portion with two or more columnar beams. In this case, it is possible to reduce vibration leakage and to provide the physical quantity detection element 70 with a high Q value by providing symmetry to vibration of each columnar beam.

Furthermore, for example, as a material, a quartz crystal vibrator that vibrates in a thickness shear vibration mode using an AT-cut quartz crystal or SC-cut crystal having a frequency temperature characteristic of a cubic curve can also be applied to the physical quantity detection element 70. Furthermore, as the physical quantity detection element 70, a surface acoustic wave (SAW) resonator as a piezoelectric vibrator may be adopted. The substrate material of the vibrator (resonator) is not limited to quartz crystal, but a piezoelectric material such as a piezoelectric single crystal, such as lithium tantalate or lithium niobate, or piezoelectric ceramics such as lead zirconate titanate may be used.

Here, the vibration (drive) method of the physical quantity detection element 70 according to the invention is not limited to piezoelectric drive. For example, the physical quantity detection element 70 according to the invention may be a vibration piece such as an electrostatic drive type physical quantity detection element using an electrostatic force or a Lorentz drive type element utilizing a magnetic force, in addition to the piezoelectric drive type physical quantity detection element using the piezoelectric substrate as described above. For example, in the case of an electrostatic drive type physical quantity detection element, since it is unnecessary to form a drive electrode and a protective film for protecting the driving electrode at a portion where distortion concentrates (vicinity of the root of the vibrating arm), it is hardly affected by thermal stress generated at the interface between the drive electrode and the protective film and the quartz crystal substrate and frequency fluctuation due to relaxation of thermal stress can be reduced. On the other hand, since it suffices to form the drive electrode and the electrode pad, the piezoelectric drive type physical quantity detection element is easy to manufacture.

### Operation of Physical Quantity Detecting Device

Next, the operation of the physical quantity detection device 100 will be described with reference to FIGS. 8A and 8B. In the figure, the Z′-axis is an axis along the direction in which gravity acts. The physical quantity detection device 100 can function as an acceleration detection sensor for detecting acceleration as a physical quantity, for example. Hereinafter, the operation in the case where acceleration is applied to the physical quantity detection device 100 will be described.

As illustrated in FIG. 8A, when acceleration α1 (acceleration applied in the direction of gravity) is applied in the −Z′-axis direction, the movable portion 14 is displaced in the −Z′-axis direction with the joint portion 12 as a fulcrum according to the acceleration α1 in the physical quantity detection device 100. With this configuration, in the physical quantity detection element 70, a force (tensile force) in the direction of an arrow β1 (away from each other) is applied to the base 72a and the base 72b along the Y′-axis, and a tensile stress in the direction of the arrow β1 is generated in the vibrating beam portions 71a and 71b. For that reason, the vibration frequency (resonance frequency) of the vibrating beam portions 71a and 71b increases.

On the other hand, as illustrated in FIG. 8B, in the physical quantity detection device 100, when acceleration α2 (acceleration applied in the opposite direction to the direction of gravity) is applied in the +Z′-axis direction, the movable portion 14 is displaced in the +Z′-axis direction with the joint portion 12 as a fulcrum according to the acceleration α2. With this configuration, in the physical quantity detection element 70, a force (compression force) in the direction of an arrow β2 (approaching each other) is applied to the base 72a and the base 72b along the Y′-axis, and a compressive stress in the 32 direction is generated in the vibrating beam portions 71a and 71b. For that reason, the vibration frequency (resonance frequency) of the vibrating beam portions 71a and 71b becomes low.

Here, as illustrated in FIGS. 8A and 8B, in a case where the accelerations α1 and α2 applied in the Z′-axis direction are larger than a predetermined magnitude, the connection portion 40 can contact the mass portions 80 and 82. For that reason, displacement of the movable portion 14 in the Z′-axis direction can be regulated within a predetermined range by the connection portion 40. With this configuration, damage to the physical quantity detection device 100 due to excessive displacement of the movable portion 14 can be suppressed.

In this embodiment, although an example in which a so-called double-tuning fork element (double-tuning fork type vibration element) is used as the physical quantity detection element 70 is described, as long as the vibration frequency changes based on the displacement of the movable portion 14 and the physical quantity can be detected, the form of the physical quantity detection element 70 is not particularly limited as described above.

According to the first embodiment described above, the inclined portion 26 as a corner portion having the configuration described above is provided at the corner on the inner side of the connection portion to which the first portion 121 along the Y′-axis and the second portion 129 along the +X-direction of the X-axis are connected. With this configuration, the crystalline plane having different etching rates in the wet etching is not exposed by the inclined portion 26, so that it is possible to prevent (to make it hard to cause) the occurrence of the residue 95 (see FIG. 5) generated at the inner side of the connection portion which has been generated in the related art. With this configuration, in a case where an impact is applied to the physical quantity detection device 100, a stress concentrated portion that can become a starting point of destruction such as folding can be eliminated and impact resistance of the physical quantity detection device 100 can be improved. With this configuration, it is unnecessary to make the substrate structure 101 thicker than necessary, so that sensitivity of the physical quantity detection device 100 can be increased. Accordingly, it is possible to obtain the physical quantity detection device 100 with high sensitivity while maintaining the impact resistance.

### Second Embodiment

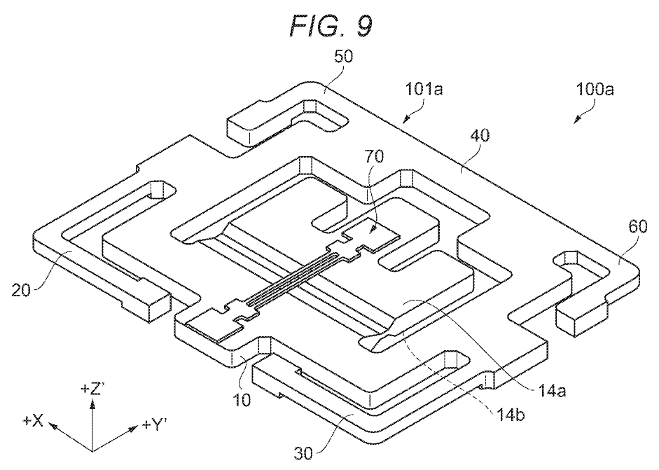

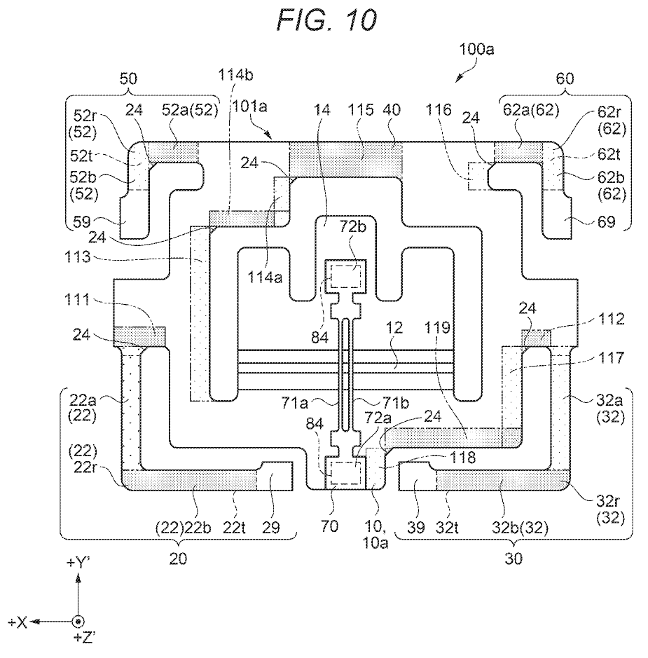

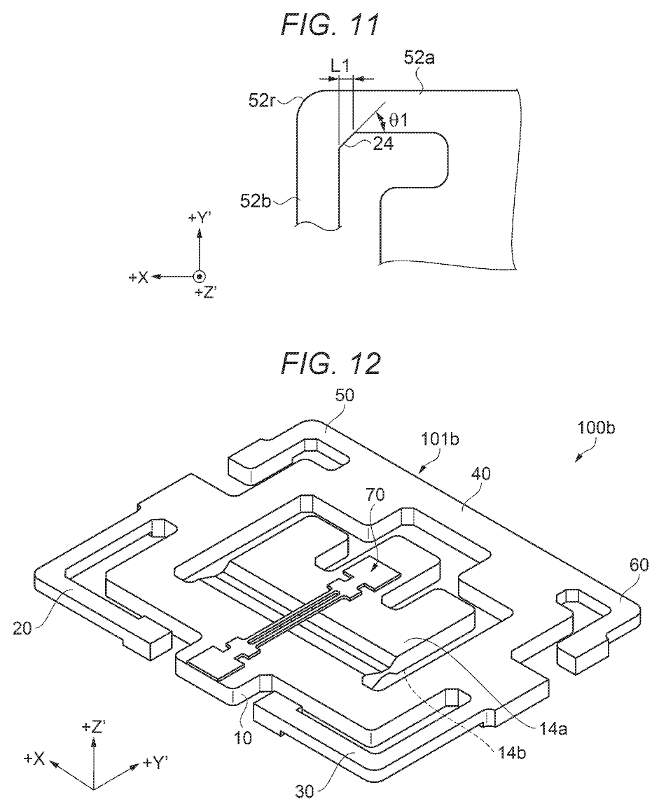

Next, a physical quantity detection device according to a second embodiment will be described with reference to FIGS. 9, 10, and 11. FIG. 9 is a perspective view schematically illustrating a physical quantity detection device according to a second embodiment. FIG. 10 is a plan view schematically illustrating the physical quantity detection device according to the second embodiment. FIG. 11 is an enlarged plan view illustrating the connection portion (corner portion) of the physical quantity detection device. A physical quantity detection device 100a according to the second embodiment illustrated in FIGS. 9, 10, and 11 is different from the physical quantity detection device 100 according to the first embodiment described above in that an inclined portion 24 is provided instead of the inclined portion 26, and the other configuration is the same. Accordingly, in the following description, disposition of the inclined portions 24 having a different configurations will be mainly described, and the same reference numerals are given to the same configurations, and description thereof will be omitted.

As illustrated in FIGS. 9, 10 and 11, the physical quantity detection device 100a according to the second embodiment includes the base 10, the joint portion 12, the movable portion 14 connected to the base 10, the connection portion 40, and the physical quantity detection element 70 for detecting a physical quantity. Here, similar to the first embodiment, the base 10 is a region that is identified by oblique lines in FIG. 3 (a region indicated by hatching that rises to the right as seen in a plan view). Although not illustrated, the physical quantity detection device 100a also includes the mass portions 80 and 82 as illustrated in the first embodiment.

Furthermore, the physical quantity detection device 100a includes the first supporter 20, the second supporter 30, the third supporter 50, and the fourth supporter 60 which are provided so as to be connected to the base 10 side. Here, the third supporter 50 and the fourth supporter 60 are connected through the connection portion 40.

Specifically, the first supporter 20 is disposed on the plus side of the X-axis of the base 10 in a plan view. The second supporter 30 is disposed on the negative side of the X-axis of the base 10 in a plan view. The third supporter 50 is disposed on the plus side of the Y-axis with respect to the first supporter 20 in a plan view and is disposed on the plus side of the X-axis of the base 10. The fourth supporter 60 is disposed on the plus side of the Y-axis with respect to the second supporter 30 in a plan view and is disposed on the negative side of the X-axis of the base 10.

The physical quantity detection device 100a of this embodiment exemplifies a form having four supporters (first supporter 20, second supporter 30, third supporter 50, and fourth supporter 60) as an example. However, the number of the supporters to be provided is not limited to four supporters, and may be appropriately changed according to the condition of the physical quantity to be detected and the like. For example, a configuration in which there is no connection portion 40 which is disposed between the third supporter 50 and the fourth supporter 60 and connects the third supporter 50 and the fourth supporter 60, and the third supporter 50 and the fourth supporter 60 are not connected may be available.

The physical quantity detection device 100a according to the second embodiment has a configuration in which the inclined portion 24 as a corner portion is provided in a substrate structure 101a. Since other configurations of the physical quantity detection device 100a are the same as those of the physical quantity detection device 100 of the first embodiment described above, the description thereof will be omitted here. In the substrate structure 101a of this embodiment, the inclined portions 24 are arranged at seven places.

The inclined portion 24 as a corner portion is provided at an inner side of a connection region to which a first portion along the Y′-axis and a second portion along the +X-direction of the X-axis are connected and is inclined at an inclination angle θ1 with respect to the X-axis. It is preferable that the inclination angle θ1 of the inclined portion 24 satisfies 25°≤θ1≤35°.

Hereinafter, as a representative example of the inclined portion 24 in the substrate structure 101a of this embodiment, the inclined portion 24 provided at the connection portion between the fifth arm portion 52a and the sixth arm portion 52b constituting the third supporter 50 will be described. In this example, as illustrated in FIG. 11, the fifth arm portion 52a corresponds to the first portion provided along the Y′-axis, and the sixth arm portion 52b corresponds to the second portion provided along the +X-direction of the X-axis. In a plan view, the inclined portion 24 is provided at the corner on the inner side of the surface of the connection region, to which the fifth arm portion 52a as the first portion and the sixth arm portion 52b as the second portion are connected, such that the inclination angle θ1 of the outer edge with respect to the X-axis satisfies 25°≤θ1≤35°. The inclined portion 24 is provided so as to overlap the residue (not illustrated) appearing when the inclined portion 24 is not provided in a plan view in the Z-axis direction.

As illustrated in FIG. 11, it is preferable that the inclined portion 24 is provided to satisfy 300 μm≤t1≤500 μm and 100 μm≤L1≤500 μm when t1 (in other words, it can be said to be the thickness of the fifth arm portion 52a and the sixth arm portion 52b (see FIG. 7)) is a thickness of the inclined portion 24 and L11 is a length of the inclined portion 24 along the X-axis. With such a configuration, as described with reference to the graph of FIG. 6, it is possible to increase shear strength in the X-direction.

As such, since the crystalline plane having different etching rates disappear by providing the inclined portion 24 as a corner portion having the configuration described above at the inner side of the connection portion to which the fifth arm portion 52a as the first portion provided along the Y′-axis and the sixth arm portion 52b as the second portion provided along the +X-direction of the X-axis are connected, it is possible to prevent the occurrence of the residue generated at the inner side of the connection portion in which the inclined portion 24 is not provided in the related art. With this configuration, in a case where an impact is applied to the physical quantity detection device 100a, a stress concentrated portion that can become a starting point of destruction such as folding can be eliminated and impact resistance of the physical quantity detection device 100a can be improved.

In addition to the inner side of the connection portion to which the fifth arm portion 52a as the first portion and the sixth arm portion 52b as the second portion are connected in the matters described above as the representative example, the inclined portion 24 can also be disposed at the connection portion between the first portion provided along the Y′-axis and the second portion provided along the +X-direction of the X-axis, and the same effect can be obtained. Specifically, the inclined portion 24 in this embodiment is provided at a connection portion between the first arm portion 22a as the first portion and the second portion 111, a connection portion between the first portion 113 and the second portion 114b, a connection portion between the first portion 114a and the second portion 115, a connection portion between the first portion 116 and the seventh arm portion 62a as the second portion, a connection portion between the first portion 117 and the second portion 112, and a connection portion between the first portion 118 and the second portion 119, as other disposition places. In FIG. 10, approximate regions in each of the first portion and the second portion are indicated by hatching.

According to the second embodiment described above, the inclined portion 24 as a corner portion having the configuration described above is provided at the corner on the inner side of the connection portion (third curved portion 52r) to which, for example, the sixth arm portion 52b provided along the Y′-axis and the fifth arm portion 52a provided along the +X-direction of the X-axis are connected. With this configuration, the crystalline plane having different etching rates in the wet etching is not exposed by the inclined portion 24, so that it is possible to prevent (to make it hard to cause) the occurrence of the residue generated at the inner side of the connection portion. With this configuration, in a case where an excessive impact is applied to the physical quantity detection device 100a, a stress concentrated portion that can become a starting point of destruction such as folding can be eliminated and impact resistance of the physical quantity detection device 100a can be improved. With this configuration, it is unnecessary to make the substrate structure 101a thicker than necessary, so that sensitivity of the physical quantity detection device 100a can be increased. Accordingly, it is possible to obtain the physical quantity detection device 100a with high sensitivity while maintaining the impact resistance.

### Third Embodiment

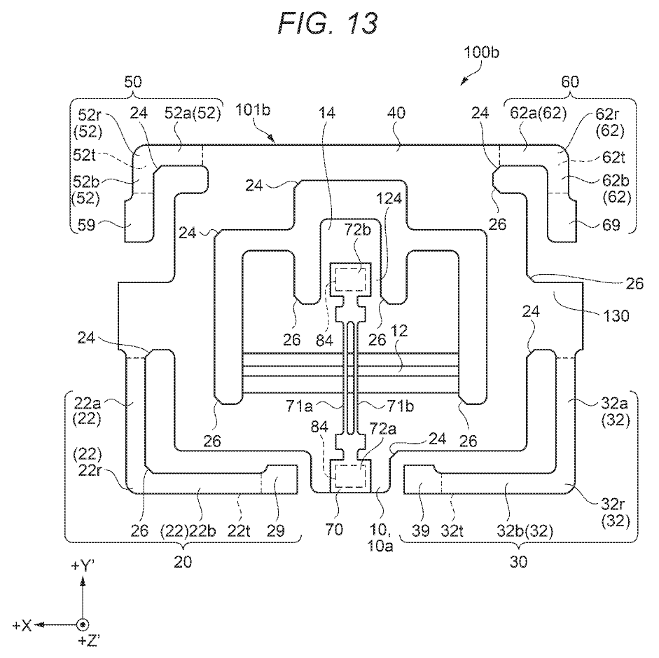

Next, a physical quantity detection device according to a third embodiment will be described with reference to FIGS. 12 and 13. FIG. 12 is a perspective view schematically illustrating a physical quantity detection device according to a third embodiment. FIG. 13 is a plan view schematically illustrating the physical quantity detection device according to the third embodiment. The physical quantity detection device 100b according to the third embodiment illustrated in FIGS. 12 and 13 has a configuration in which the inclined portion 26 provided in the physical quantity detection device 100 according to the first embodiment described above and the inclined portion 24 provided the physical quantity detection device 100a according to the second embodiment are disposed, the other configurations are the same. Accordingly, in the following description, disposition of the inclined portion 26 and the inclined portion 24 will be mainly described, and the same reference numerals are given to the same configurations as in the embodiments described above, and the description thereof will be omitted.

As illustrated in FIGS. 12 and 13, the physical quantity detection device 100b according to the third embodiment includes the base 10, the joint portion 12, the movable portion 14 connected to the base 10, the connection portion 40, and a physical quantity detection element 70 to detect a physical quantity. Here, similar to the first embodiment, the base 10 is a region (region indicated by hatching that rises to the right in a plan view) that is identified by oblique lines in FIG. 3. Although not illustrated, the physical quantity detection device 100b also includes the mass portions 80 and 82 as illustrated in the first embodiment.

Furthermore, the physical quantity detection device 100b includes the first supporter 20, the second supporter 30, the third supporter 50, and the fourth supporter 60 which are provided so as to be connected to the base 10. Here, the third supporter 50 and the fourth supporter 60 are connected through the connection portion 40.

Specifically, the first supporter 20 is disposed on the plus side of the X-axis of the base 10 in a plan view. The second supporter 30 is disposed on the negative side of the X-axis of the base 10 in a plan view. The third supporter 50 is disposed on the plus side of the Y-axis with respect to the first supporter 20 in a plan view and is disposed on the plus side of the X-axis of the base 10. The fourth supporter 60 is disposed on the plus side of the Y-axis with respect to the second supporter 30 in a plan view and is disposed on the negative side of the X-axis of the base 10.

The physical quantity detection device 100b of this embodiment exemplifies a form, in which four supporters (first supporter 20, second supporter 30, third supporter 50, and fourth supporter 60) are included, as an example. However, the number of the supporters to be provided is not limited the four supporters, and may be appropriately changed according to the condition of the physical quantity to be detected and the like. For example, a configuration in which there is no connection portion 40 that is disposed between the third supporter 50 and the fourth supporter 60 and connects the third supporter 50 and the fourth supporter 60, and the third supporter 50 and the fourth supporter 60 are not connected may be available.

The physical quantity detection device 100b according to the third embodiment has a configuration in which the inclined portion 24 described in the second embodiment is provided in the substrate structure 101b, in addition to the inclined portion 26 described in the first embodiment. In the substrate structure 101b of this embodiment, the inclined portion 26 and the inclined portion 24 as the corner portions are disposed at seven places, respectively. Since the detailed configuration of the inclined portion 26 and the inclined portion 24 is the same as matters described above, a detailed description thereof will be omitted.

According to the third embodiment described above, the inclined portion 26 and the inclined portion 24 as the corner portions are provided at the inner sides of all of the connection portion (for example, first curved portion 22r) to which the first portion (for example, first arm portion 22a) provided along the Y′-axis and the second portion (for example, the second arm portion 22b) provided along the +X-direction of the X-axis are connected. With this configuration, the crystalline planes having different etching rates in the wet etching are not exposed by the inclined portion 24 and the inclined portion 26, so that it is possible to prevent (to make it hard to cause) the occurrence of the residue. With this configuration, in a case where an excessive impact is applied to the physical quantity detection device 100b, a stress concentrated portion that can become a starting point of destruction such as folding can be eliminated and impact resistance of the physical quantity detection device 100b can be improved. With this configuration, it is unnecessary to make the substrate structure 101b thicker than necessary, so that sensitivity of the physical quantity detection device 100b can be increased. Accordingly, it is possible to obtain the physical quantity detection device 100b with high sensitivity while maintaining the impact resistance.

### Fourth Embodiment

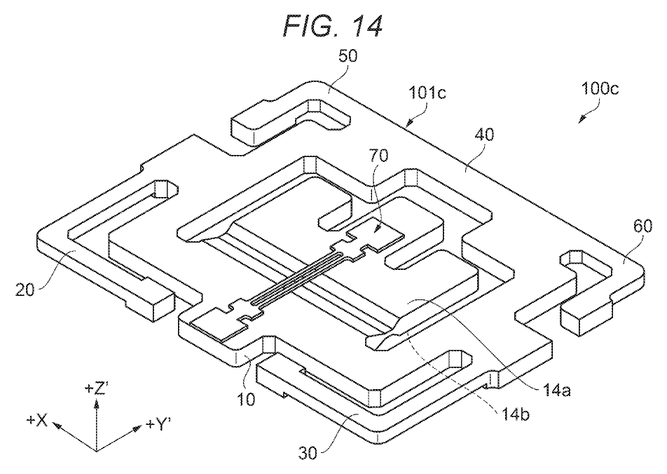

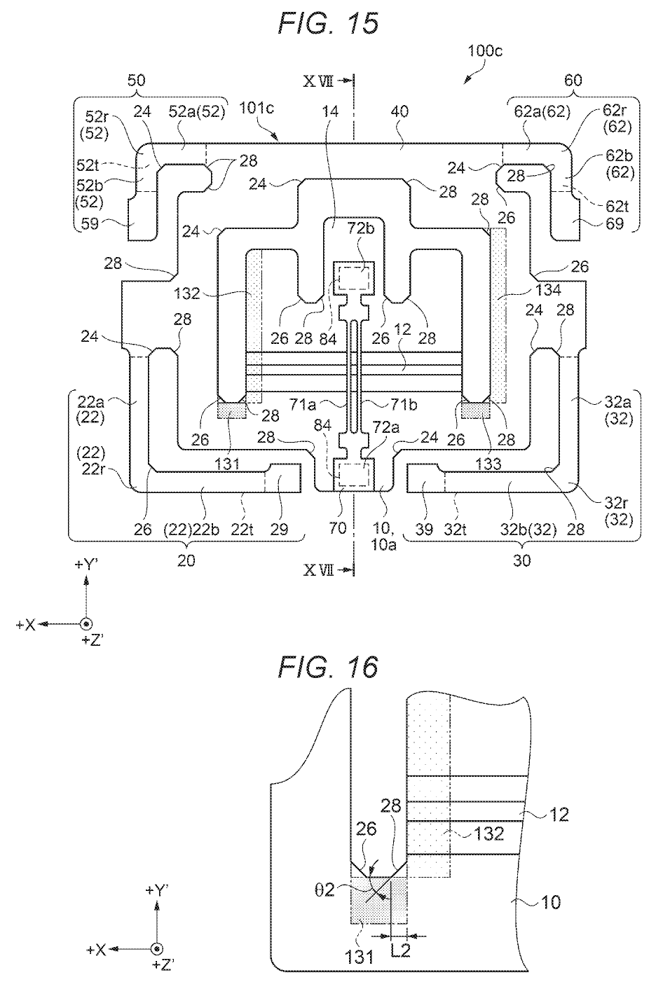

Next, a physical quantity detection device according to a fourth embodiment will be described with reference to FIGS. 14, 15, and 16. FIG. 14 is a perspective view schematically illustrating the physical quantity detection device according to the fourth embodiment. FIG. 15 is a plan view schematically illustrating the physical quantity detection device according to the fourth embodiment. FIG. 16 is an enlarged plan view illustrating the connection portion (corner portion) of the physical quantity detection device. A physical quantity detection device 100c according to the fourth embodiment illustrated in FIGS. 14 and 15 has a configuration in which a third inclined portion 28 as a second corner portion is disposed in addition to the inclined portions 24 and 26, in comparison with the physical quantity detection device 100a according to the second embodiment, and the other configurations are the same. Accordingly, in the following description, disposition of the third inclined portion 28 having a different configurations will be mainly described, and the same reference numerals are given to the same configurations as in the embodiments described above, and the description thereof will be omitted.

As illustrated in FIGS. 14 and 15, the physical quantity detection device 100c according to the fourth embodiment includes the base 10, the joint portion 12, the movable portion 14 connected to the base 10, the connection portion 40, and a physical quantity detection element 70 to detect a physical quantity. Here, similar to the first embodiment, the base 10 is a region (region indicated by hatching that rises to the right in a plan view) that is identified by oblique lines in FIG. 3. Although not illustrated, the physical quantity detection device 100c also includes the mass portions 80 and 82 as illustrated in the first embodiment.

Furthermore, the physical quantity detection device 100c includes the first supporter 20, the second supporter 30, the third supporter 50, and the fourth supporter 60 which are provided so as to be connected to the base 10. Here, the third supporter 50 and the fourth supporter 60 are connected through the connection portion 40.

Specifically, the first supporter 20 is disposed on the plus side of the X-axis of the base 10 in a plan view. The second supporter 30 is disposed on the negative side of the X-axis of the base 10 in a plan view. The third supporter 50 is disposed on the plus side of the Y-axis with respect to the first supporter 20 in a plan view and is disposed on the plus side of the X-axis of the base 10. The fourth supporter 60 is disposed on the plus side of the Y-axis with respect to the second supporter 30 in a plan view and is disposed on the negative side of the X-axis of the base 10.

The physical quantity detection device 100c of this embodiment exemplifies a form, in which four supporters (first supporter 20, second supporter 30, third supporter 50, and fourth supporter 60) are included, as an example. However, the number of the supporters to be provided is not limited the four supporters, and may be appropriately changed according to the condition of the physical quantity to be detected and the like. For example, a configuration in which there is no connection portion 40 that is disposed between the third supporter 50 and the fourth supporter 60 and connects the third supporter 50 and the fourth supporter 60, and the third supporter 50 and the 4 supporter 60 are not connected may be available.

The physical quantity detection device 100c according to the fourth embodiment has a configuration in which the substrate structure 101c is provided with the third inclined portion 28 as the second corner portion in addition to the inclined portions 24 and 26 described in the third embodiment.

The third inclined portion 28 as the second corner portion is provided at an inner side of a surface of a connection region to which third portions 132 and 134 provided along the Y′-axis and fourth portions 131 and 133 along the −X-direction of the X-axis are connected. The inclined portion 28 is inclined at an inclination angle θ2 with respect to the X-axis. It is preferable that the inclination angle θ2 of the third inclined portion 28 satisfies 25°≤θ2≤35°.

As illustrated in FIG. 16, it is preferable that third inclined portion 28 is provided to satisfy 300 μm≤t2≤500 μm and 100 μm≤L2≤500 μm when t2 (in other words, it can be said to be the thickness of the base 10 (see FIG. 7)) is a thickness (thickness in the Z-axis direction) of the third inclined portion 28 and L2 is a length of the third inclined portion 28 along the X-axis. With such a configuration, as described with reference to the graph of FIG. 6, it is possible to increase shear strength in the X-direction.

The third inclined portion 28 is provided on the inner side of the connection portion at a position symmetrical to disposition positions of the inclined portions 24 and 26 described in the third embodiment so as to be symmetrical with the shapes of the inclined portions 24 and 26 along the Y′-axis illustrated in FIG. 15 with the line segment XVII-XVII passing through the center of the physical quantity detection element 70 as the center line. In the substrate structure 101c of this embodiment, the third inclined portion 28 is arranged at fourteen places.

According to the described above fourth embodiment, the plurality of third inclined portions 28 are disposed symmetrically with respect to the disposition positions of the inclined portions 24 and 26 described in the third embodiment in the same figure with the line segment XVII-XVII passing through the center of the physical quantity detection element 70 as a center line. Accordingly, since the configuration of the substrate structure 101c has structural symmetry in the physical quantity detection device 100c, in addition to the effects of any of the first embodiment to the third embodiment, it is possible to reduce occurrence of unnecessary resonance mode signals (spurious signals), and prevent fluctuation of the output signal output from the physical quantity detection device 100c due to a combination of the unnecessary resonance mode signals (spurious signals) and the detection signal of the physical quantity detection element 70 in the physical quantity detection device 100c.

In each embodiment described above, the X-axis, the Y′-axis, and the Z′-axis are orthogonal to each other, but may not be strictly orthogonal. For example, the X-axis may be slightly inclined with respect to the normal direction of the Y′Z′-plane, the Y-axis may be slightly inclined with respect to the normal direction of the XZ′-plane, or the Z′-axis may be slightly inclined with respect to the normal direction of the XY′-plane. The term “slightly” means a range in which the physical quantity detection devices 100, 100a, 100b, and 100c can exert their effects, and a specific inclination angle (numerical value) varies depending on the configuration and the like.

Each of the physical quantity detection devices 100, 100a, 100b, and 100c of the embodiments can be applied as the acceleration sensor for detecting acceleration described above. Each of the physical quantity detection devices can also be applied as an inertial sensor, vibration sensor (vibrometer), gravity sensor (gravimeter), and inclination sensor (inclinometer).

### Physical Quantity Detector

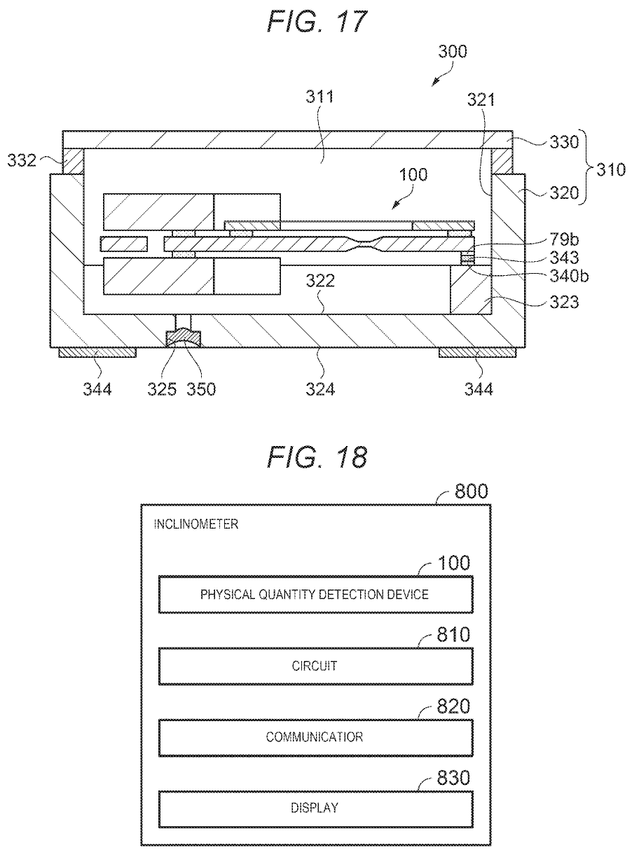

Next, with reference to FIG. 17, description will be made on a physical quantity detector including any one of the physical quantity detection devices 100, 100a, 100b, and 100c described above. FIG. 17 is a cross-sectional view schematically illustrating a physical quantity detector. In the following description of the physical quantity detector, a configuration in which the physical quantity detection device 100 is mounted will be exemplified and described.

As illustrated in FIG. 17, in a physical quantity detector 300, the physical quantity detection device 100 described in the first embodiment is mounted (accommodated). Since the configuration of the mounted physical quantity detection device 100 is the same as that of the first embodiment, the same reference numerals are given to the same configurations, and the description thereof will be simplified or omitted.

As illustrated in FIG. 17, the physical quantity detector 300 includes the physical quantity detection device 100 according to the first embodiment described above and a package 310. The package 310 includes a package base 320 and a lid 330. In the physical quantity detector 300 of this embodiment, the physical quantity detection device 100 is accommodated (mounted) in the package 310. More specifically, the physical quantity detection device 100 is accommodated (mounted) in a space 311 provided by connecting the package base 320 and the lid 330.

The package base 320 includes a recessed portion 321, and the physical quantity detection device 100 is provided in the recessed portion 321. A shape of the package base 320 is not particularly limited as long as the physical quantity detection device 100 can be provided in the recessed portion 321. In this embodiment, for example, ceramics is used as the package base 320, but is not limited thereto. Materials such as quartz crystal, glass, silicon, and the like can be used.

The package base 320 includes a step portion 323 protruding toward the lid 330 side from the inner bottom surface (bottom surface inside the recessed portion 321) 322 of the package base 320. The step portion 323 is provided along the inner wall of the recessed portion 321, for example. The step portion 323 is provided with a plurality of internal terminals 340b.

The internal terminal 340b is disposed at a position (position overlapping in a plan view) facing the fixed portion connection terminal (for example, fixed portion connection terminal 79b) provided in each of the fixed portions 29, 39, 59, and 69 of the physical quantity detection device 100. For example, the fixed portion connection terminal 79b provided in the second fixed portion 39 is electrically connected to the internal terminal 340b through a bonding material 343. As the bonding material 343, for example, a silicone resin-based conductive adhesive containing a conductive substance such as a metal filler can be used.

Each of the fixed portions 29, 39, 59, and 69 provided on each of the supporters 20, 30, 50, and 60 is fixed to the recessed portion 321 through the bonding material 343 so that the physical quantity detection device 100 is mounted on the package base 320 and accommodated in the package 310.

On the outer bottom surface (surface on the side opposite to the inner bottom surface 322) 324 of the package base 320, external terminals 344 used when being mounted on an external member are provided. The external terminal 344 is electrically connected to the internal terminal 340b through an internal wiring (not illustrated).

The internal terminal 340b and the external terminal 344 are made of a metal film formed by laminating a film of nickel (Ni), gold (Au) or the like by a method such as plating or the like on a metalized layer such as tungsten (W).

In the package base 320, a sealing portion 350 for sealing the inside (cavity) of the package 310 is provided at the bottom of the recessed portion 321. The sealing portion 350 is provided in a through hole 325 formed in the package base 320. The through hole 325 penetrates from the outer bottom surface 324 to the inner bottom surface 322. In the example illustrated in FIG. 17, the through hole 325 has a stepped shape in which a hole diameter on the outer bottom surface 324 side is larger than the hole diameter on the inner bottom surface 322 side. The sealing portion 350 is provided by disposing a sealing material made of, for example, gold (Au) and germanium (Ge) alloy, and solder in the through hole 325, heating and melting the sealing material, and then solidifying the sealing material. The sealing portion 350 is provided to hermetically seal the inside of the package 310.

The lid 330 is provided so as to cover the recessed portion 321 of the package base 320. The shape of the lid 330 is, for example, a plate shape. As the lid 330, for example, the same material as the package base 320, an alloy of iron (Fe) and nickel (Ni), a metal such as stainless steel or the like can be used. The lid 330 is joined to the package base 320 through a lid joining member 332. As the lid joining member 332, for example, a seam ring, a low melting point glass, an inorganic adhesive or the like can be used.

After the lid 330 is joined to the package base 320, the inside of the package 310 can be hermetically sealed by disposing a sealing material in the through hole 325, heating and melting, solidifying the sealing material, and providing the sealing portion 350 in a state where the inside of the package 310 is decompressed (in a state of high degree of vacuum). The inside of the package 310 may be filled with an inert gas such as nitrogen, helium, argon, or the like.

When a drive signal is given to the excitation electrode of the physical quantity detection device 100 through the external terminal 344, the internal terminal 340b, the fixed portion connection terminal 79b, and the like in the physical quantity detector 300, the vibrating beam portions 71a and 71b of the physical quantity detection elements 70 vibrate (resonate) at a predetermined frequency. The physical quantity detector 300 can output the resonance frequency of the physical quantity detection element 70 which changes according to the applied accelerations α1 and α2 as an output signal.

An electronic circuit (not illustrated) for processing an output signal output from the physical quantity detection device 100 may be mounted on the physical quantity detector 300. In the physical quantity detector 300, a drive signal is given from the electronic circuit to the excitation electrode of the physical quantity detection device 100 through the internal terminal 340b, the fixed portion connection terminal 79b, and the like. When the drive signal is applied, the vibrating beam portions 71a and 71b of the physical quantity detection element 70 perform bending vibration (resonate) at a predetermined frequency. Then, the physical quantity detector 300 can amplify the resonance frequency output from the physical quantity detection element 70, which changes according to the applied accelerations α1 and α2, by the electronic circuit and output the resonance frequency from the external terminal 344 to the outside of the physical quantity detector 300.

In a case where the physical quantity detection device 100 is used as the physical quantity detector 300 for detecting an inclination as a physical quantity, the direction in which gravity acceleration is applied changes according to the change in the attitude (inclination) of the physical quantity detector 300 and tensile stress and compressive stress are generated in the vibrating beam portions 71a and 71b of the mounted physical quantity detection device 100. Then, the resonance frequency of the vibrating beam portions 71a and 71b changes. The physical quantity detector 300 detects the change in the resonance frequency as change in the attitude (inclination).

According to the physical quantity detector 300 described above, since the physical quantity detection device 100 having improved impact resistance and high sensitivity is provided, the physical quantity detector 300 can also achieve the same effect.

### Inclinometer

Next, with reference to FIG. 18, an inclinometer including any one of the physical quantity detection devices 100, 100a, 100b, and 100c described above will be described. FIG. 18 is a functional block diagram illustrating a schematic configuration of the inclinometer. In the following description of the inclinometer, a configuration in which the physical quantity detection device 100 is mounted will be exemplified and described. An inclinometer 800 is installed in a structure such as a bridge or a building, for example, and can measure the inclination (tilt) of the installed structure.

As illustrated in FIG. 18, the inclinometer 800 includes the physical quantity detection device 100 and a circuit 810 that calculates an inclination of a structure installed based on an output signal from the physical quantity detection device 100. The inclinometer 800 includes a communicator 820 that communicates calculation data relating to the inclination of the structure calculated by the circuit 810 with other information terminals and a display 830 for displaying the calculation data relating to the inclination of the structure calculated by the circuit 810.

The physical quantity detection device 100 can function as an inclination sensor for detecting an inclination. The physical quantity detection device 100 can output the change in the resonance frequency of the vibrating beam portions 71a and 71b of the physical quantity detection element 70 as an output signal.

The circuit 810 is configured by a micro controller unit (MCU) or the like, and controls each unit of the inclinometer 800. The circuit 810 can calculate the inclination of the structure on which the inclinometer 800 is installed based on the output signal from the physical quantity detection device 100, and output the inclination as a predetermined signal. The circuit 810 can process the calculated inclination of the structure and output the inclination as display data to the display 830 to be displayed on the display 830.

The communicator 820 performs various controls for establishing communication between the inclinometer 800 and an information terminal (not illustrated). The communicator 820 may be configured to include a transmitter and receiver compatible with, for example, a short distance wireless communication standard such as Bluetooth (registered trademark) (including BTLE: Bluetooth Low Energy)), wireless fidelity (Wi-Fi), Zigbee (registered trademark), near field communication (NFC), ANT+ (registered trademark) and a connector compatible with a communication bus standard such as a universal serial bus (USB).

The display 830 displays a state of the inclination of the installed structure based on the output signal from the circuit 810. As display on the display 830, display by characters (pictograms), image display including graphic display, and the like can be performed.

According to such an inclinometer 800, since the inclination is calculated based on the output signal from the physical quantity detection device 100 detected with high sensitivity while maintaining the impact resistance, it is possible to perform calculation of the inclination with improved reliability.

### Inertial Measurement Unit

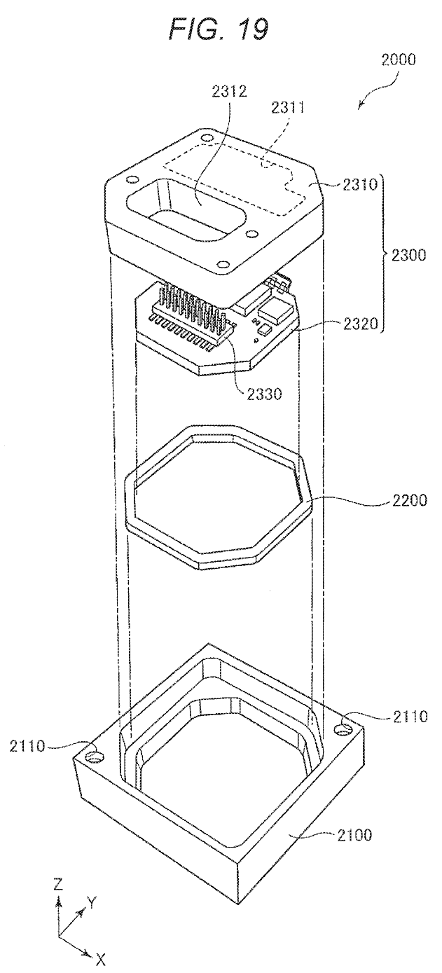

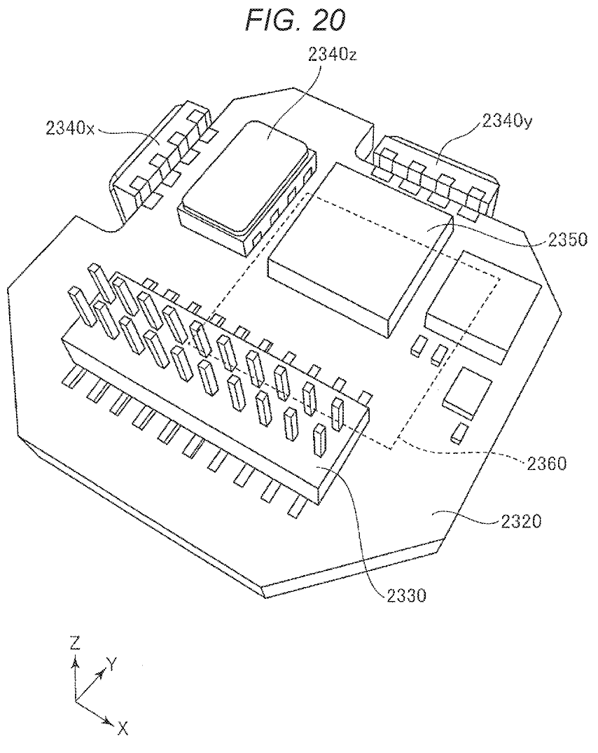

Next, with reference to FIGS. 19 and 20, an inertial measurement unit (IMU) will be described. FIG. 19 is an exploded perspective view illustrating a schematic configuration of an inertial measurement unit. FIG. 20 is a perspective view illustrating a disposition example of inertial sensor elements of the inertial measurement unit. In FIGS. 19 and 20, the X-axis, Y-axis, and Z-axis are illustrated as three axes orthogonal to each other.

An inertial measurement unit 2000 (IMU) illustrated in FIG. 19 is a device that detects the attitude and behavior (inertial momentum) of a vehicle (mounted device) such as an automobile or a robot. The inertial measurement unit 2000 functions as a so-called six-axis motion sensor including three-axis acceleration sensors and three-axis angular velocity sensors.

The inertial measurement unit 2000 is a rectangular parallelepiped having a substantially square planar shape. Screw holes 2110 as fixed portions are formed in the vicinity of two vertices positioned in the diagonal direction of the square. Through two screws in the two screw holes 2110, the inertial measurement unit 2000 can be fixed to the mounted surface of the mounted object such as an automobile. The size of the inertial measurement unit 2000 can be reduced such that the device can be mounted on a smartphone or a digital camera, for example, by selection of parts or design change.

The inertial measurement unit 2000 has a configuration in which an outer case 2100, a bonding member 2200, and a sensor module 2300 are included and the sensor module 2300 is inserted in the outer case 2100 with the bonding member 2200 interposed therebetween. Further, the sensor module 2300 includes an inner case 2310 and a substrate 2320.

Similarly to the overall shape of the inertial measurement unit 2000, the outer shape of the outer case 2100 is a rectangular parallelepiped having a substantially square planar shape, and screw holes 2110 are formed in the vicinity of two vertices positioned in the diagonal direction of the square. In addition, the outer case 2100 has a box shape and the sensor module 2300 is accommodated therein.

The inner case 2310 is a member for supporting the substrate 2320, and has a shape so as to fit inside the outer case 2100. A recessed portion 2311 for preventing contact with the substrate 2320 and an opening 2312 for exposing a connector 2330 described later are formed in the inner case 2310. Such an inner case 2310 is bonded to the outer case 2100 via the bonding member 2200 (for example, a packing impregnated with adhesive). The substrate 2320 is bonded to the lower surface of the inner case 2310 via an adhesive.

As illustrated in FIG. 20, a connector 2330, an angular velocity sensor 2340z for measuring the angular velocity around the Z-axis, an acceleration sensor 2350 for measuring acceleration in each axis directions of the X-axis, the Y-axis, and the Z-axis and the like are mounted on the upper surface of the substrate 2320. An angular velocity sensor 2340x for measuring the angular velocity about the X-axis and an angular velocity sensor 2340y for measuring the angular velocity around the Y-axis are mounted on the side surface of the substrate 2320. The angular velocity sensors 2340z, 2340x, and 2340y are not particularly limited, and gyro sensors using the Coriolis force or the like can be used. Further, the acceleration sensor 2350 is not particularly limited, and the physical quantity detector 300 in which any one of the physical quantity detection devices 100, 100a, 100b, and 100c described in the first to fourth embodiments described above is accommodated can be used for the acceleration sensor 2350. The acceleration sensor 2350 can detect acceleration in each of three axial directions (X-axis, Y-axis, and Z-axis) orthogonal to each other, and three physical quantity detectors 300 accommodating any one of the physical quantity detection devices 100, 100a, 100b, and 100c according to the invention are mounted in the acceleration sensor 2350.

A control IC 2360 is mounted on the lower surface of the substrate 2320. The control IC 2360 is a micro controller unit (MCU), which includes a storing unit including a nonvolatile memory, an A/D converter, and the like, and controls each unit of the inertial measurement unit 2000. In the storing unit, programs defining the order and contents for measuring the acceleration and angular velocity, programs for digitizing detected data and incorporating the detected data into packet data, accompanying data, and the like are stored. A plurality of electronic components are mounted on the substrate 2320 in addition to the control IC 2360.

The inertial measurement unit 2000 has been described as above. Such an inertial measurement unit 2000 includes the angular velocity sensors 2340z, 2340x, and 2340y and the acceleration sensors 2350, and the control IC 2360 (control circuit) as a circuit for controlling driving of each of these sensors 2340z, 2340x, 2340y, and 2350. With this configuration, the inertial measurement unit 2000 capable of achieving the effect of the physical quantity detection device 100 described above and having high impact resistance and high reliability can be obtained.

### Electronic Apparatus

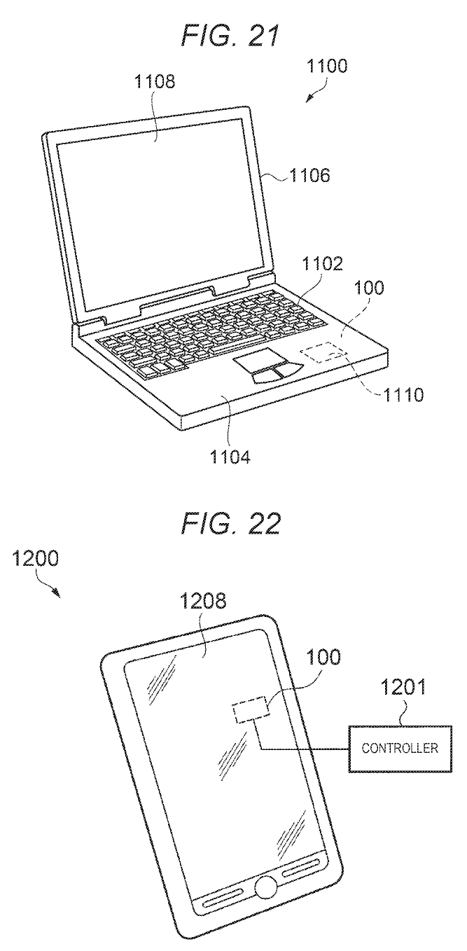

Next, electronic apparatuses using any one of the physical quantity detection devices 100, 100a, 100b, and 100c will be described with reference to FIGS. 21, 22, and 23. In the following description, a configuration using the physical quantity detection device 100 will be described by way of an example.

First, with reference to FIG. 21, a mobile type personal computer which is an example of an electronic apparatus will be described. FIG. 21 is a perspective view schematically illustrating a configuration of a mobile type personal computer which is an example of an electronic apparatus.

In this figure, the personal computer 1100 is configured by a main body 1104 including a keyboard 1102 and a display 1106 including a display 1108, and the display 1106 is supported so as to be rotatable with respect to the main body 1104 via a hinge structure. In the personal computer 1100, the physical quantity detection device 100 functioning as an angular velocity sensor is built therein, and the controller 1110 can perform control such as attitude control based on the output signal of the detection data of the physical quantity detection device 100.

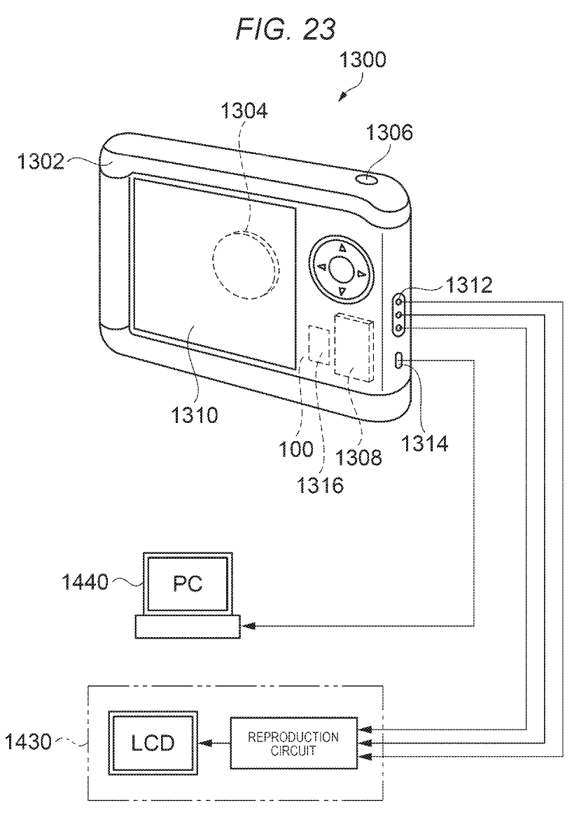

FIG. 22 is a perspective view schematically illustrating a configuration of a smartphone (mobile phone) which is an example of an electronic apparatus.

In this figure, the physical quantity detection device 100 described above is incorporated in the smartphone 1200. An output signal of detection data (angular velocity data) detected by the physical quantity detection device 100 is transmitted to the controller 1201 of the smartphone 1200. The controller 1201 is configured to include a central processing unit (CPU), can recognize the attitude and behavior of the smartphone 1200 from the output signal of the received detection data, change a display image displayed on the display 1208, generate an alarm sound or effect sound, or drive a vibration motor to vibrate a main body. In other words, it is possible to perform motion sensing of the smartphone 1200, change display content, generate sound, vibration, and the like from the measured attitude and behavior. In particular, when executing an application of a game, it is possible to enjoy realistic feeling close to reality.

FIG. 23 is a perspective view illustrating a configuration of a digital still camera which is an example of electronic apparatus. In this figure, connection with an external device is also illustrated briefly.

In this figure, a display 1310 is provided on the back surface of a case (body) 1302 of the digital still camera 1300 and is configured to perform display based on the image pickup signal by the CCD, and the display 1310 function as a viewfinder to display the subject as an electronic image. A light receiver 1304 including an optical lens (image pickup optical system) and a CCD or the like is provided on the front surface side (back surface side in the figure) of the case 1302.

When a photographer confirms a subject image displayed on the display 1310 and presses a shutter button 1306, the image pickup signal of the CCD at that time is transferred to and stored in the memory 1308. Also, in the digital still camera 1300, a video signal output terminal 1312 and an input and output terminal 1314 for data communication are provided on the side surface of the case 1302. As illustrated, a TV monitor 1430 and a personal computer 1440 are connected to the video signal output terminal 1312 and the input and output terminal 1314 for data communication, respectively, as necessary. Furthermore, a configuration in which the image pickup signal stored in the memory 1308 is output to the TV monitor 1430 or the personal computer 1440 by a predetermined operation is adopted. In such a digital still camera 1300, the physical quantity detection device 100 functioning as an acceleration sensor is built in and the controller 1316 can perform control, for example, camera shake correction based on the output signal of the detection data of the physical quantity detection device 100.

Since such an electronic apparatus includes the physical quantity detection device 100 and the controllers 1110, 1201, and 1316, the electronic apparatus has excellent reliability.

In addition to the personal computer of FIG. 21, the smartphone (mobile phone) of FIG. 22, and the digital still camera of FIG. 23, the electronic apparatus including the physical quantity detection device 100 can be applied to, for example, a tablet terminal, a watch, an ink jet type discharging device (for example, an ink jet printer), a laptop personal computer, a TV, a video camera, a video tape recorder, a car navigation device, a pager, an electronic datebook (including a datebook with communication function), an electronic dictionary, a calculator, an electronic game machines, a word processor, a work station, a videophone, a security TV monitor, an electronic binoculars, a POS terminal, medical equipment (for example, electronic clinical thermometer, blood pressure monitor, blood glucose meter, electrocardiogram measurement device, ultrasonic diagnostic device, electronic endoscope), a fish finder, various measuring instruments, instruments (for example, instruments of vehicles, aircraft, and ships), a flight simulator, a seismograph, a pedometer, an inclinometer, a vibrometer that measures vibration of a hard disk, a posture control device of a flying object such as a robot or a drone, a control device used for inertial navigation for automatic operation of an automobile, and the like.

### Vehicle

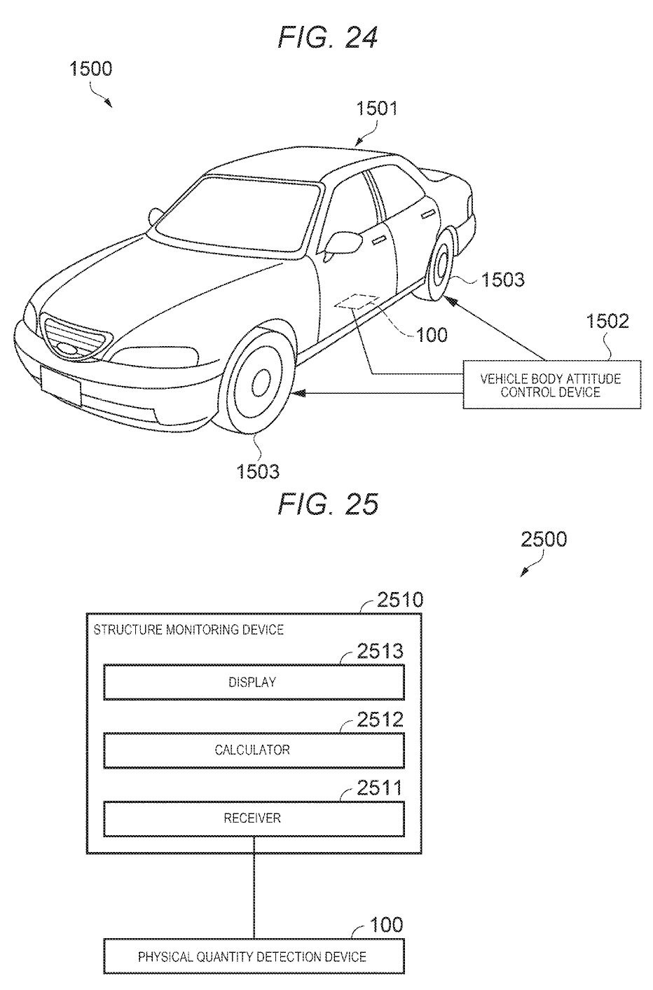

Next, a vehicle using the physical quantity detection devices 100, 100a, 100b, and 100c is illustrated in FIG. 24, and will be described in detail. FIG. 24 is a perspective view illustrating a configuration of an automobile which is an example of a vehicle. In the following description, a configuration using the physical quantity detection device 100 will be described by way of example.

As illustrated in FIG. 24, the physical quantity detection device 100 is built in an automobile 1500, and for example, the attitude of a vehicle body 1501 can be detected by the physical quantity detection device 100. A detection signal (output signal) of the physical quantity detection device 100 is supplied to a vehicle body attitude control device 1502 as an attitude controller for controlling the attitude of the vehicle body, and the vehicle body attitude control device 1502 measures the attitude of the vehicle body 1501 based on the detection signal, control hardness of a suspension according to the detection result, or control brakes of individual wheels 1503. In addition, the physical quantity detection device 100 can also be widely applied to a keyless entry system, an immobilizer, a car navigation system, a car air conditioner, an anti-lock braking system (ABS), an air bag, a tire pressure monitoring system (TPMS), an engine control system (engine system), a control device for inertial navigation for automatic operation, and an electronic controller (ECU) such as a battery monitor of a hybrid car or an electric automobile.

Further, in addition to the examples described above, the physical quantity detection device 100 applied to the vehicle may also be used for control, for example, attitude control of a biped walking robot, a train, and the like, remote control of such as s radio control airplane, a radio control helicopter, a drone, and the like or attitude control of autonomous aircraft, attitude control of an agricultural machine (farm machine) or a construction machine (construction equipment), control of a rocket, an artificial satellite, a ship, an automatic guided vehicle (AGV), and the like. As described above, the physical quantity detection device 100 and respective controllers (not illustrated) are incorporated in realizing attitude control of various vehicles and vehicles.

Since such a vehicle includes the physical quantity detection device 100 and a controller (for example, a vehicle body attitude control device 1502 as an attitude controller), the vehicle has excellent reliability.

### Structure Object Monitoring System

Next, a structure monitoring system using the physical quantity detection devices 100, 100a, 100b, and 100c is illustrated in FIG. 25, and will be described in detail. FIG. 25 is a functional block diagram illustrating a structure monitoring system. In the following description, a configuration using the physical quantity detection device 100 will be exemplified and described.

A structure monitoring system 2500 can detect displacement such as an inclination angle and deflection of a structure based on the detection result of the physical quantity detection device 100 installed in the structure such as a bridge or a beam of a building. As illustrated in FIG. 25, the structure monitoring system 2500 includes the physical quantity detection device 100 and a structure monitoring device 2510 that can receive the detection result of the physical quantity detection device 100 and can monitor the displacement of the structure.

The structure monitoring device 2510 includes a receiver 2511 for receiving the detection result output from the physical quantity detection device 100 attached to the structure as an output signal and a calculator 2512 that calculates the inclination angle of the structure to which the physical quantity detection device 100 is attached based on the output signal received and output by the receiver 2511. The structure monitoring device 2510 may include a display 2513 capable of displaying the inclination angle and displacement of the structure calculated by the calculator 2512 as characters, graphic images, or the like.

According to such a structure monitoring system 2500, since the inclination and displacement of the structure are calculated based on the output signal from the physical quantity detection device 100 detected with high sensitivity while maintaining impact resistance, it is possible to calculate the inclination and displacement of the structure with high reliability.

Although the physical quantity detection device, the inclinometer, the inertial measurement unit, the electronic apparatus, the vehicle, and the structure monitoring system have been described as above based on the illustrated embodiments, the invention is not limited thereto, the configuration of each unit can be replaced with any configuration having the same function. Further, any other constituent may be added to the invention.

The entire disclosure of Japanese Patent Application No. 2018-029434, filed Feb. 22, 2018, is expressly incorporated by reference herein.

What is claimed is:

1. A physical quantity detection device, comprising:
a quartz crystal substrate having a plane including a Z′-axis and a Y′-axis, when an axis obtained by inclining a Z-axis by a rotation angle ϕ so that a +Z side rotates in a −Y-direction of a Y-axis is set as the Z′-axis and an axis obtained by inclining the Y-axis by the rotation angle ϕ so that a +Y side of the Y-axis rotates in a +Z-direction of the Z-axis is set as the Y′-axis, with an X-axis of an orthogonal coordinate system including the X-axis as an electric axis, the Y-axis as a mechanical axis, and the Z-axis as an optical axis of quartz crystal as a rotation axis;
a base;
a movable portion connected to the base;
a physical quantity detection element connected to the base and the movable portion and detecting a physical quantity; and
a supporter connected to the base,
wherein an outer edge on an inner side of a surface of a connection region to which a first portion along the Y′-axis and a second portion along the +X-direction of the X-axis are connected includes a corner portion inclined with respect to the X-axis in a plan view, and
25°≤θ1≤35° is satisfied, where θ1 is an inclination angle of the corner portion with respect to the X-axis.

2. The physical quantity detection device according to claim 1,
wherein the corner portion satisfies
300 μm≤t1≤500 μm and
100 μm≤L1≤500 μm,
where t1 is a thickness of the corner portion and L1 is a length along the X-axis of the corner portion.

3. The physical quantity detection device according to claim 1,
wherein an outer edge on an inner side of a surface of a connection region to which a third portion along the Y′-axis and a fourth portion along the −X-direction of the X-axis are connected, includes a second corner portion inclined with respect to the X-axis in a plan view, and
25°≤θ2≤35° is satisfied,
where θ2 is an inclination angle of the second corner portion with respect to the X-axis.

4. The physical quantity detection device according to claim 3,
wherein the second corner portion satisfies
300 μm≤t2≤500 μm and
100 μm≤L2≤500 μm,
where t2 is a thickness of the second corner portion and L2 is a length along the X-axis of the second corner portion.

5. The physical quantity detection device according to claim 1,
wherein the physical quantity detection element includes
a first base,
a second base, and
a vibrating portion which is disposed between the first base and the second base and is connected to the first base and the second base in a plan view.

6. The physical quantity detection device according to claim 5,
wherein the vibrating portion is configured with of a plurality of vibrating arms arranged side by side with a gap therebetween in a plan view.

7. The physical quantity detection device according to claim 1,
wherein the physical quantity is acceleration.

8. An inclinometer comprising:
the physical quantity detection device according to claim 1; and
a circuit that calculates an inclination based on an output signal from the physical quantity detection device.

9. An inertial measurement unit comprising:
the physical quantity detection device according to claim 7;
an angular velocity detection device; and
a circuit for calculating an attitude based on an output signal from the physical quantity detection device and an output signal from the angular velocity detection device.

10. An electronic apparatus comprising:
the physical quantity detection device according to claim 1; and
a controller that performs control based on an output signal from the physical quantity detection device.

11. A vehicle comprising:
the physical quantity detection device according to claim 1; and
an attitude controller that controls an attitude based on a detection signal output from the physical quantity detection device.

12. A structure monitoring system comprising:
the physical quantity detection device according to claim 1 attached to a structure;
a receiver that receives a detection signal of the physical quantity detection device; and
a calculator that calculates an inclination angle of the structure based on the output signal output from the receiver.
